(19) United States
(12) Patent Application Publication
(10) Pub. No.: US 2014/0255572 A1
(43) Pub. Date: Sep. 11, 2014

(54) FOOD PREPARATION SYSTEM AND METHOD

(71) Applicant: Kyle Jacob Lewallen, College Station, TX (US)

(72) Inventor: Kyle Jacob Lewallen, College Station, TX (US)

(21) Appl. No.: 14/136,013

(22) Filed: Dec. 20, 2013

Related U.S. Application Data
(60) Provisional application No. 61/773,380, filed on Mar. 6, 2013.

(51) Int. Cl. A47J 47/00

(52) U.S. Cl. CPC A47J 47/005
USPC 426/416; 269/13

(57) ABSTRACT

A food preparation system/method configured for operation with the tailgate of a pickup truck or recreational vehicle is disclosed. The system integrates a food-grade cutting board with lifting/installation handles that may incorporate drainage lips linked to peripheral drainage channels configured to collect liquids and other waste products associated with the food preparation process. The system is configured such that drainage lips used to collect waste liquids employ ridge projections to utilize the surface tension of draining liquids to localize the ejection of liquid waste products. The drainage lips may be configured with an optional drain pipe to further localize the transfer of waste liquids to a bucket or other receptacle. The system may be configured to maintain lateral stability on the tailgate platform via the use of a rear retaining lip and/or one or more slots configured to capture the tailgate support cables/chains.

### CROSS REFERENCE TO RELATED APPLICATIONS

### U.S. Provisional Patent Applications

This application claims benefit under 35 U.S.C. §119 and incorporates by reference U.S. Provisional Patent Application for TAILGATE FOOD PREPARATION STRUCTURE by inventors Kyle Lewallan, filed electronically with the USPTO on Mar. 6, 2013, with Ser. No. 61/773,380, EFS ID 15132339, confirmation number 1043, docket KL-P12113.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to systems and methods for food preparation. Specifically, the present invention in many preferred embodiments has application to situations in which food preparation must be performed on the tailgate of a pickup or recreational vehicle.

Without limiting the scope of the present invention, the general field of invention scope may fall into one or more U.S. patent classifications including 296/24.1; 296/50; 296/51; 296/57.1; and 296/39.2.

### PRIOR ART AND BACKGROUND OF THE INVENTION

### Background

According to the American Tailgating association, “More than 50 million Americans will tailgate in 2012 spending more than USD$20 billion on food, equipment, travel and related goods and services. Tailgating is a lifestyle and recreational activity build on a platform of camaraderie and tradition. Tailgaters enjoy friends and family, food, recreation and loyalty to their team.”

In support of this activity, a wide variety of devices have been created to support the preparation and presentation of food and other items associated with tailgating activities. A few of these relating to food preparation are listed as follows:
Various tailgate covers are described in disclosures such as U.S. Pat. No. 2,721,777; U.S. Pat. No. 3,578,749; U.S. Pat. No. 4,089,276; U.S. Pat. No. 4,161,335; U.S. Pat. No. 4,889,378; U.S. Pat. No. 5,000,503; U.S. Pat. No. 5,136,953; U.S. Pat. No. 5,169,201; U.S. Pat. No. 5,169,202; U.S. Pat. No. 5,372,397; U.S. Pat. No. 5,732,995; U.S. Pat. No. 6,641,190; U.S. Pat. No. 7,513,557; U.S. Pat. No. 7,905,532; U.S. Pat. No. 8,061,761; U.S. Pat. No. 8,376,448;
Various cutting boards and accessories have also been described in the literature, including U.S. Pat. No. 3,877,144; U.S. Pat. No. 4,002,387; U.S. Pat. No. 4,077,123; U.S. Pat. No. 4,907,789; U.S. Pat. No. 5,386,978; U.S. Pat. No. 5,533,771; U.S. Pat. No. 5,649,734; U.S. Pat. No. 6,206,445; U.S. Pat. No. 6,941,655; U.S. Pat. No. 7,354,090; U.S. Pat. No. 8,007,021; U.S. D381564.
U.S. Design Pat. 381,564; U.S. Pat. No. 3,877,144; U.S. Pat. No. 4,002,387 describe cutting board arrangements having peripheral/open slots for the disposal of waste material associated with food preparation. Devices such as this have typically been utilized in kitchen environments and are not well adapted to use on pickup truck tailgates because they are typically too small and cannot be adjusted to affect proper removal of solid and liquid waste.
U.S. Pat. No. 6,206,445 for TAILGATE-ADAPTED CUTTING BOARD AND ACCESSORIES issued Mar. 27, 2001 to Kenneth S. Brooks describes a tailgate cutting board that is secured to the tailgate by bolted flanges and is specifically directed to a surface for cleaning fish. This patent discusses other patent disclosures of similar surfaces for fish cleaning use. The design disclosed in this patent typically restricts the surface to the width of the tailgate and is bolted to the tailgate. As with other designs disclosed in the patent literature, placing it into and out of service is time consuming and inconvenient.

A food preparation surface that is easier to install and remove is needed, especially for use in tailgating, picnics, traveling meals, and the like.

### Conventional Cutting Boards (0100)-(0400)

As depicted in FIG. 1 (0100), conventional cutting boards may incorporate a drainage collection channel (as depicted in detail in FIG. 1 (0100) (0101)) that is located on the periphery of the cutting board to collect liquid/solid waste from the food preparation process. However, these cutting boards are not well adapted for use on tailgates and the like because they lack a coordinated methodology to dispose of the waste products and also lack any methodology to stabilize the cutting board while placed on the tailgate. As the cutting board is typically constructed of food-grade plastic, it has a low coefficient of friction with respect to a tailgate assembly. This is especially true in cases where the tailgate is coated with a bed liner or other plastic protective cover. As a result, maintaining a stable contact plane between the cutting board and the tailgate can be problematic, and in some cases result in a safety issue regarding the use of knives and other cutting implements when processing food on the cutting board. It is therefore important to maintain stability of the cutting board as it is used in the context of a tailgate application. This issue is currently not addressed by the prior art.

Other cutting boards as depicted in FIG. 2 (0200) may incorporate holes/slots (0201) for waste disposal. However, when used in the context of a tailgate application, these cutting boards may contaminate the tailgate with food preparation waste products and may result in cross contamination if used in situations where meat and other food products are prepared simultaneously.

As depicted in FIG. 3 (0300), the prior art teaches that drainage channels and waste ejection ports may be incorporated in the same cutting board apparatus. However, these configurations are not amenable to use in tailgate applications because of their increased bulk and potential for tailgate contamination by the food preparation waste products. Attempts to integrate cutting boards with waste disposal apparatus are known as depicted in FIG. 4 (0400), however these configurations are not suitable for use in tailgate applications because they require fixed attachment to the tailgate and an integrated waste disposal container.

### Tailgate Adapted Cutting Boards (0500)-(0800)

As depicted in FIG. 5 (0500)-FIG. 8 (0800), a variety of tailgate/bumper adapted cutting boards and other tailgate covering apparatus are known in the prior art. Generally speaking, each of these approaches has its drawbacks. Most of the permanently attached tailgate-cover cutting board configurations as generally depicted in FIG. 5 (0500)-FIG. 6 (0600) present an unsanitary surface for food preparation and are difficult to attach/remove. Others such as the bumper-mounted version depicted in FIG. 7 (0700) are relatively cumbersome in that they require significant support bracket hardware to enable attachment to the truck bumper. Yet others as generally depicted in FIG. 8 (0800) do not provide for proper waste disposal and must incorporate special hardware (FIG. 8 (0800) items 24, 25) to ensure a stable cutting surface for the use of knives and other food preparation utensils.

### Deficiencies of the Prior Art

The prior art as detailed above suffers from the following deficiencies:
Prior art food preparation systems are difficult to install and remove from the tailgate platform.
Prior art food preparation systems lack a coordinated waste removal system optimized for tailgate applications.
Prior art food preparation systems lack a methodology to maintain stability of the cutting board in the context of a tailgate application.

While some of the prior art may teach some solutions to several of these problems, the core issue of integrating a food preparation system into the context of a truck or recreational vehicle tailgate has not been solved by the prior art.

### OBJECTIVES OF THE INVENTION

Accordingly, the objectives of the present invention are (among others) to circumvent the deficiencies in the prior art and affect the following objectives in the context of a food preparation system and method:
(1) Provide for a food preparation system and method that permits easy installation and removal from the tailgate of a truck or recreational vehicle.
(2) Provide for a food preparation system and method that permits coordinated removal of waste from the cutting board operation.
(3) Provide for a food preparation system and method that permits a cutting board to be stabilized when used in the context of a tailgate application.
(4) Provide for a food preparation system and method that permits a cutting board to support preparation of both meat and non-meat foodstuffs while maintaining a sanitary food preparation environment.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention as embodied in a system and method that integrates a food-grade cutting board with lifting/installation handles that may incorporate drainage lips linked to peripheral drainage channels configured to collect liquids and other waste products associated with the food preparation process. The system is configured such that drainage lips used to collect waste liquids employ ridge projections to utilize the surface tension of draining liquids to localize the ejection of liquid waste products. The drainage lips may be configured with an optional drain pipe to further localize the transfer of waste liquids to a bucket or other receptacle. The system may be configured to maintain lateral stability on the tailgate platform via the use of a rear retaining lip and/or one or more slots configured to capture the tailgate support cables/chains.

### BRIEF DESCRIPTION OF THE DRAWINGS

For a fuller understanding of the advantages provided by the invention, reference should be made to the following detailed description together with the accompanying drawings wherein:

FIG. 1 illustrates a prior art food preparation cutting board incorporating a peripheral drainage channel;

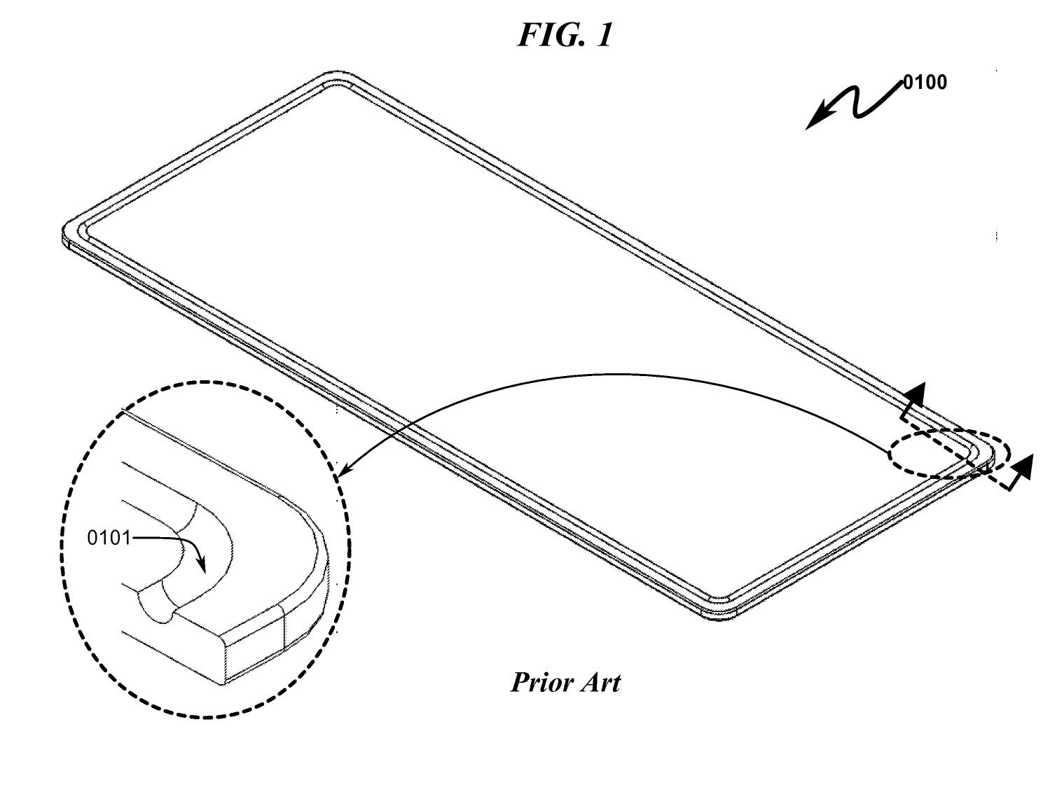

FIG. 2 illustrates a prior art cutting board as depicted in U.S. Design Pat. D381,564;

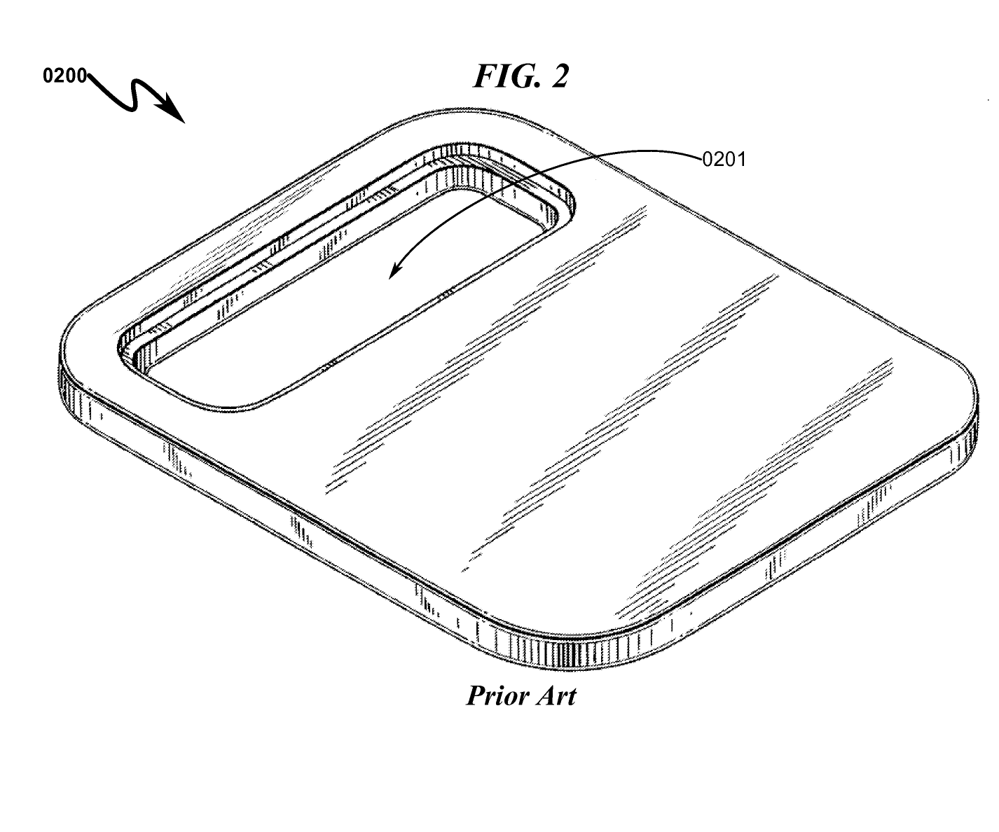

FIG. 3 illustrates a prior art cutting board as depicted in U.S. Pat. No. 4,907,789;

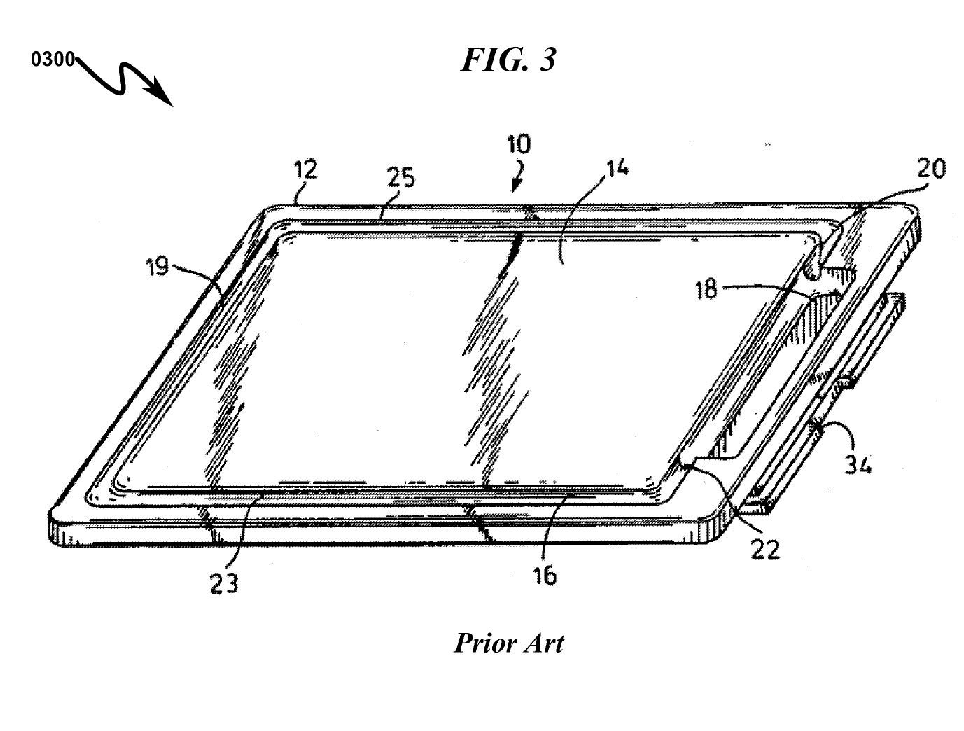

FIG. 4 illustrates a prior art cutting board as depicted in U.S. Pat. No. 4,002,387;

FIG. 5 illustrates a prior art tailgate cover as depicted in U.S. Pat. No. 4,161,335;

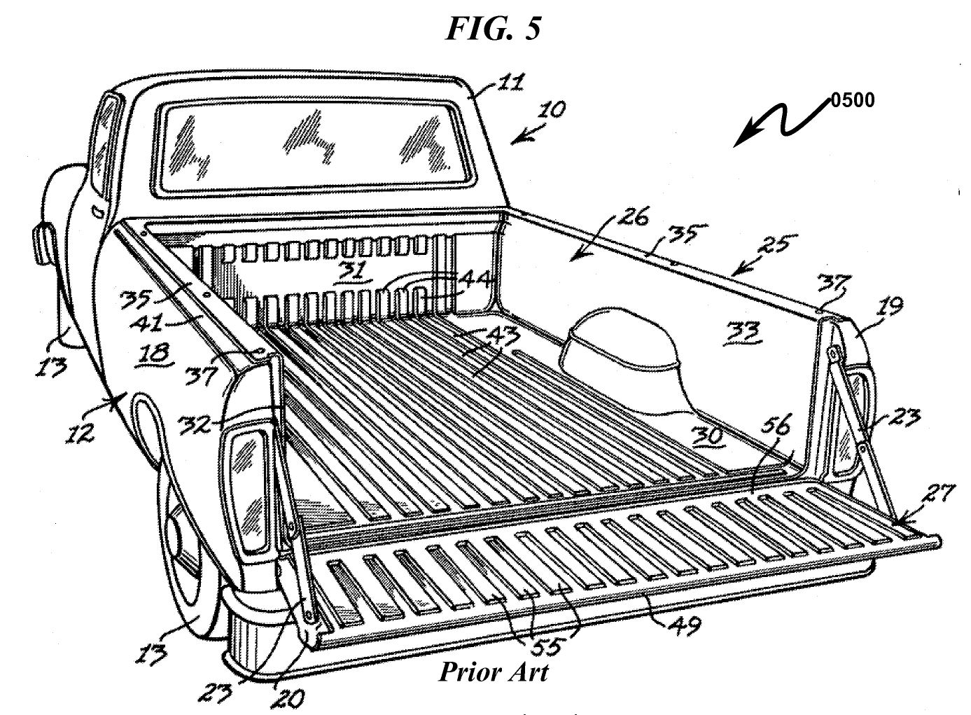

FIG. 6 illustrates a prior art tailgate cover as depicted in U.S. Pat. No. 5,000,503;

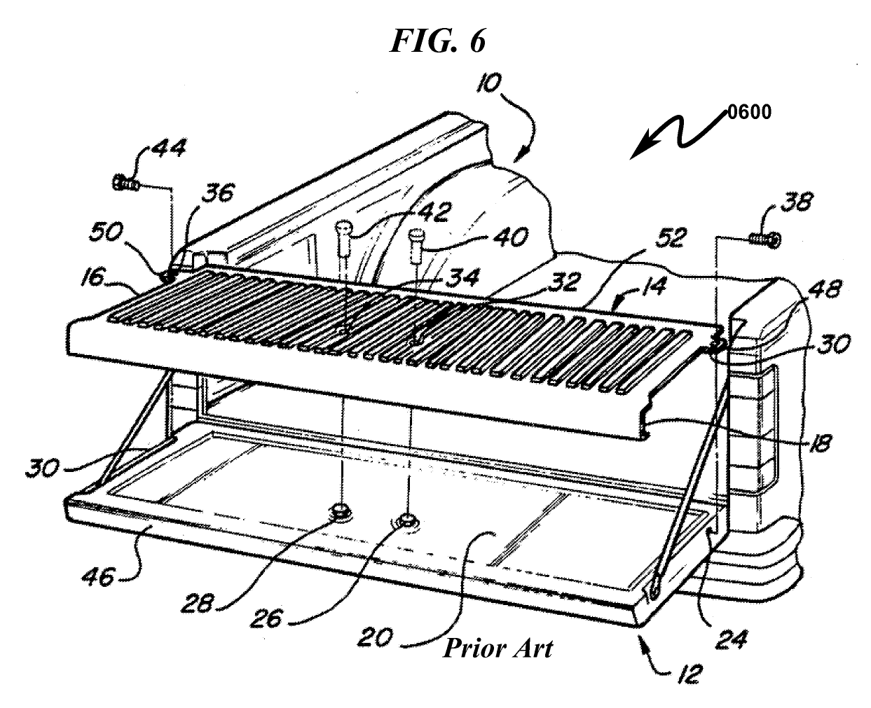

FIG. 7 illustrates a prior art bumper adapted food preparation surface as depicted in U.S. Pat. No. 4,089,276;

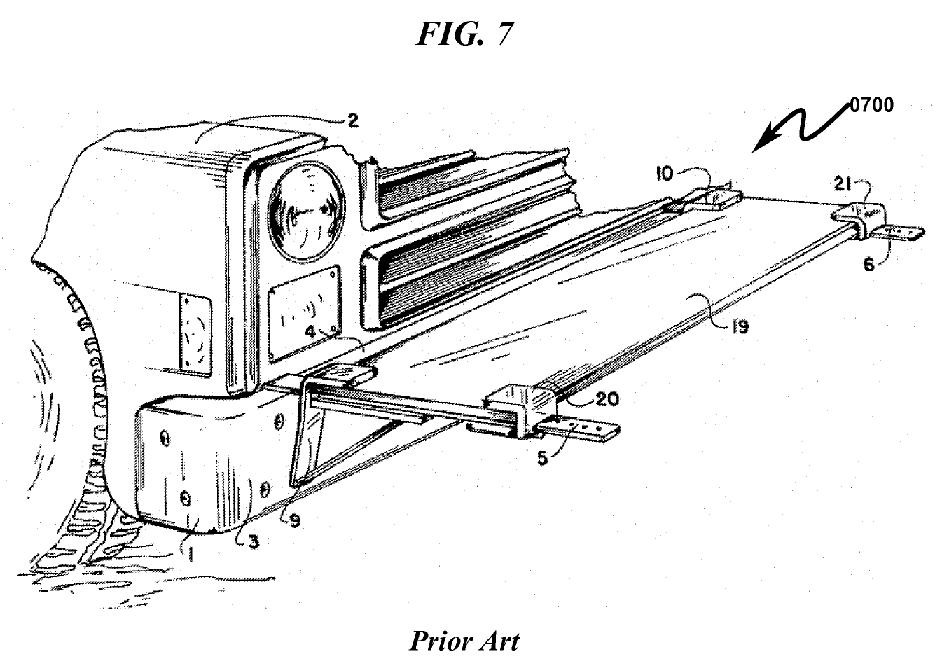

FIG. 8 illustrates a prior art tailgate adapted food preparation surface as depicted in U.S. Pat. No. 6,206,445;

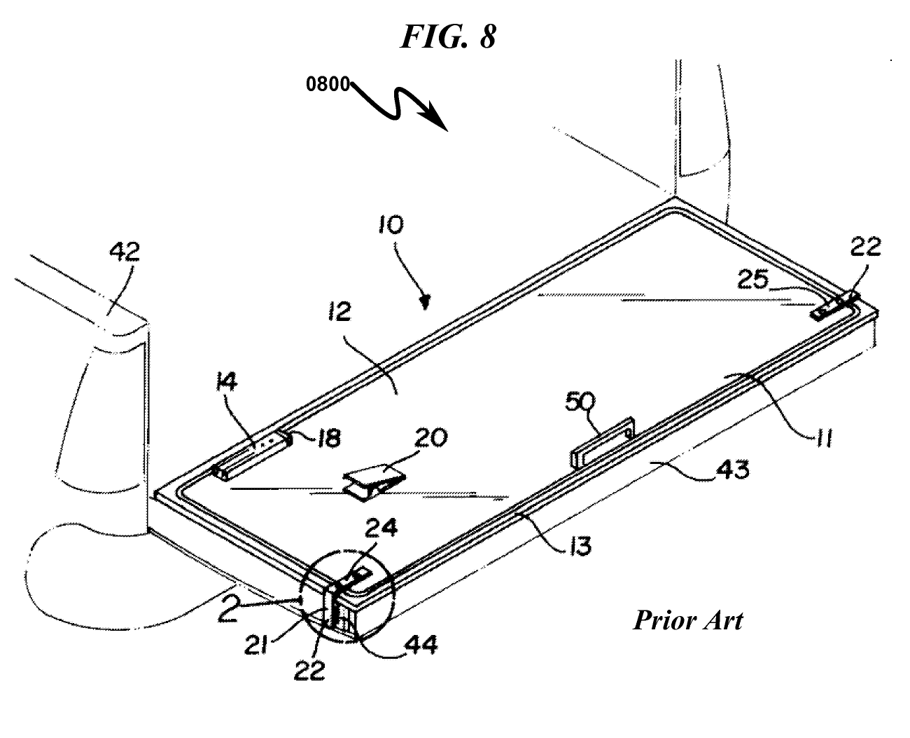

FIG. 9 illustrates a top view of a preferred exemplary invention embodiment;

FIG. 10 illustrates a top perspective view of a preferred exemplary invention embodiment;

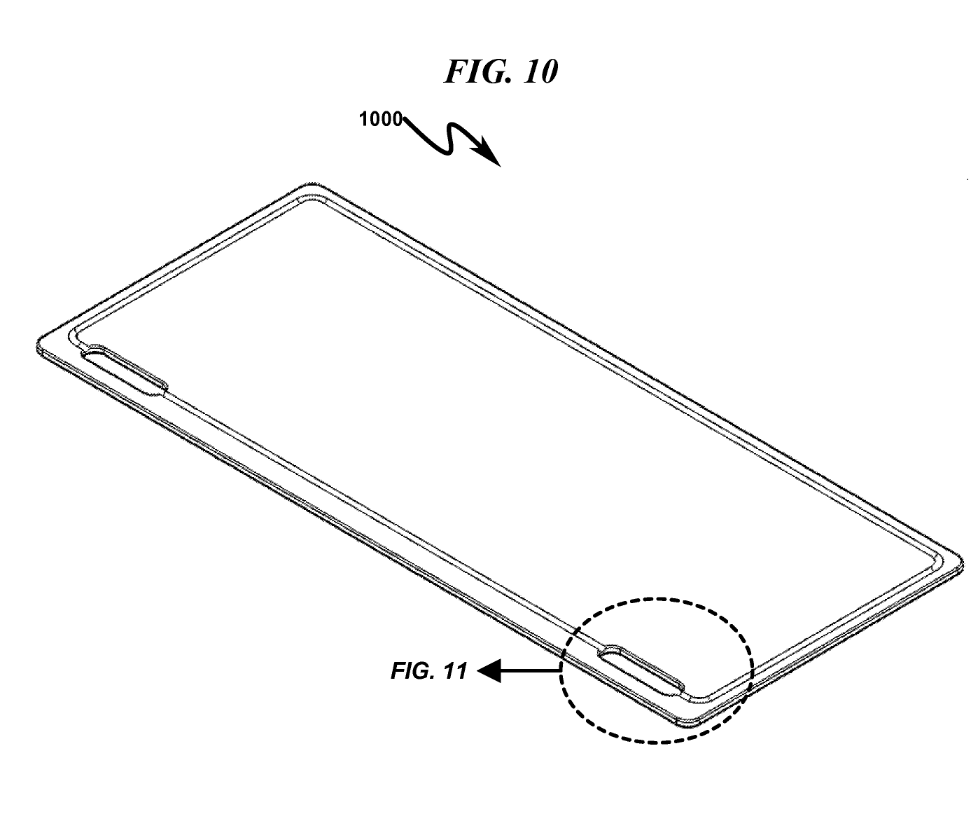

FIG. 11 illustrates a top perspective detail view of a preferred exemplary invention embodiment;

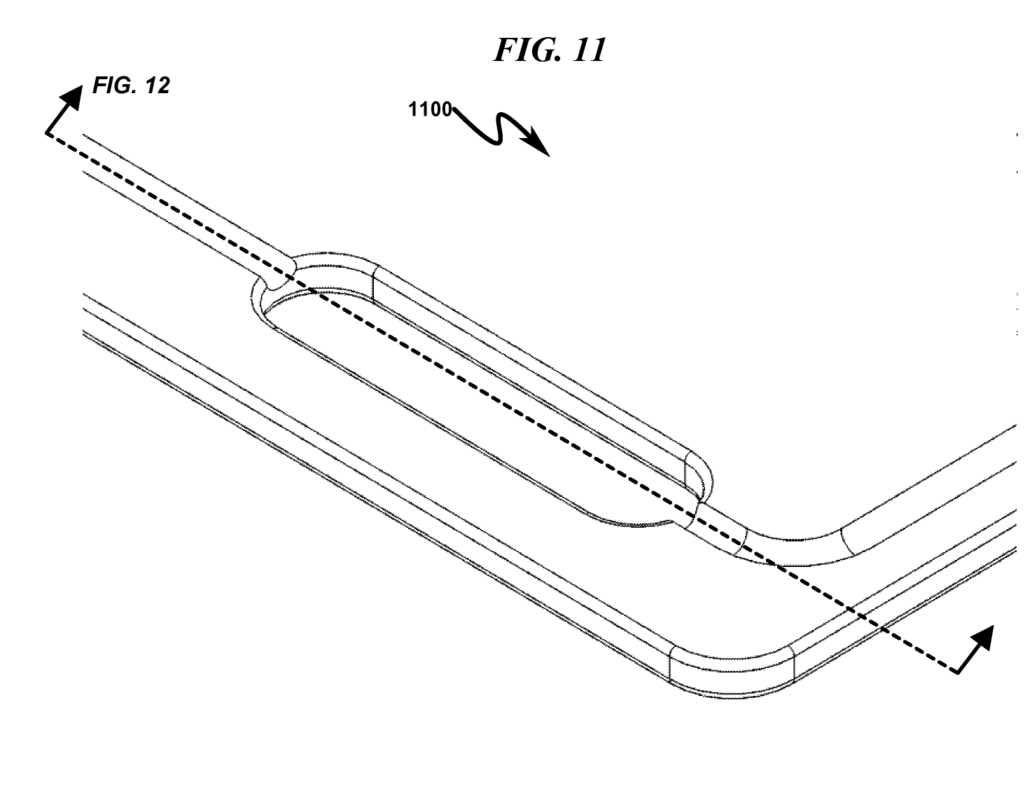

FIG. 12 illustrates a horizontal sectional view of a preferred exemplary invention embodiment;

FIG. 13 illustrates a bottom view of a preferred exemplary invention embodiment;

FIG. 14 illustrates a bottom perspective view of a preferred exemplary invention embodiment;

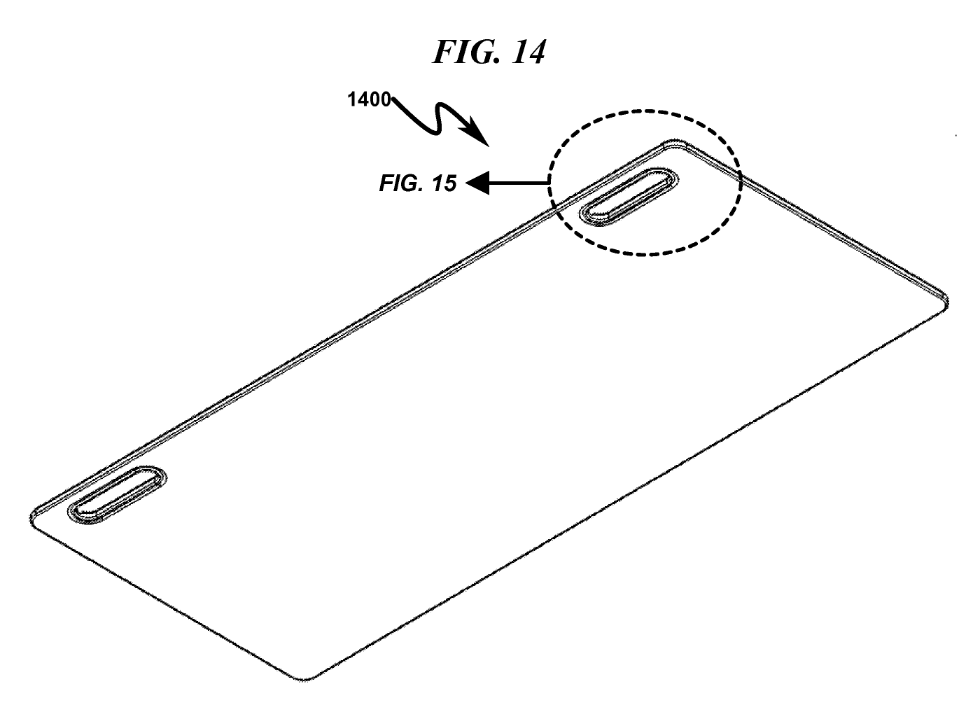

FIG. 15 illustrates a bottom perspective detail view of a preferred exemplary invention embodiment;

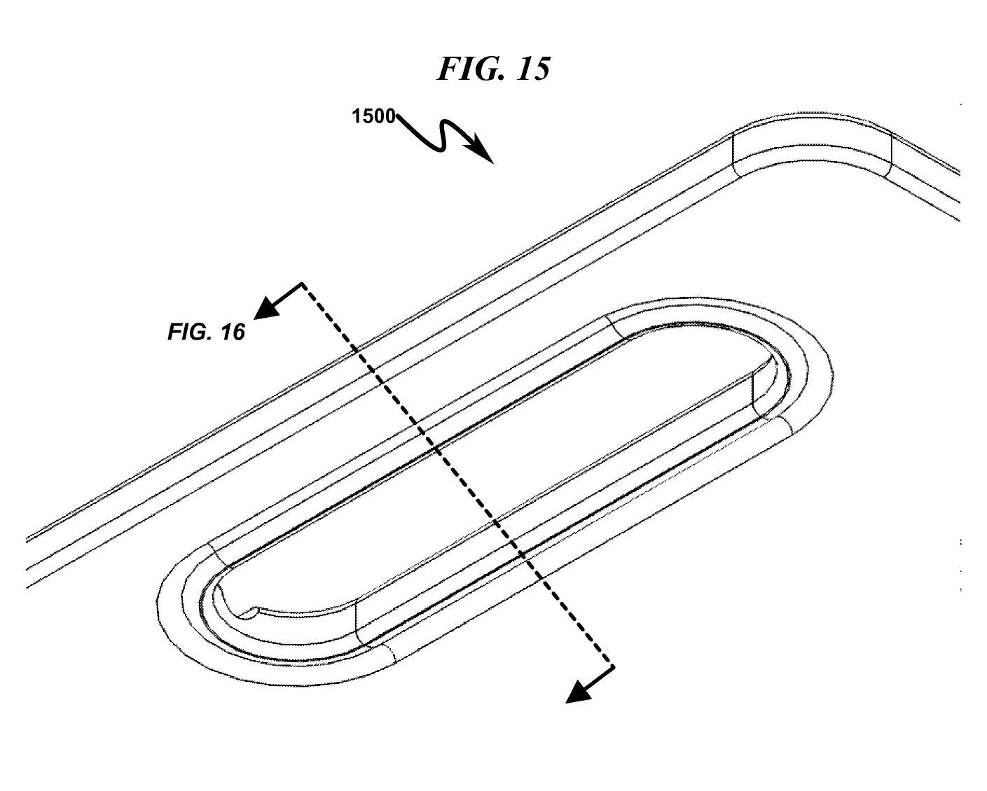

FIG. 16 illustrates a vertical sectional view of a preferred exemplary invention embodiment;

FIG. 17 illustrates a top view of an alternate preferred exemplary invention embodiment incorporating separated food preparation surfaces;

FIG. 18 illustrates a top perspective view of an alternate preferred exemplary invention embodiment incorporating separated food preparation surfaces;

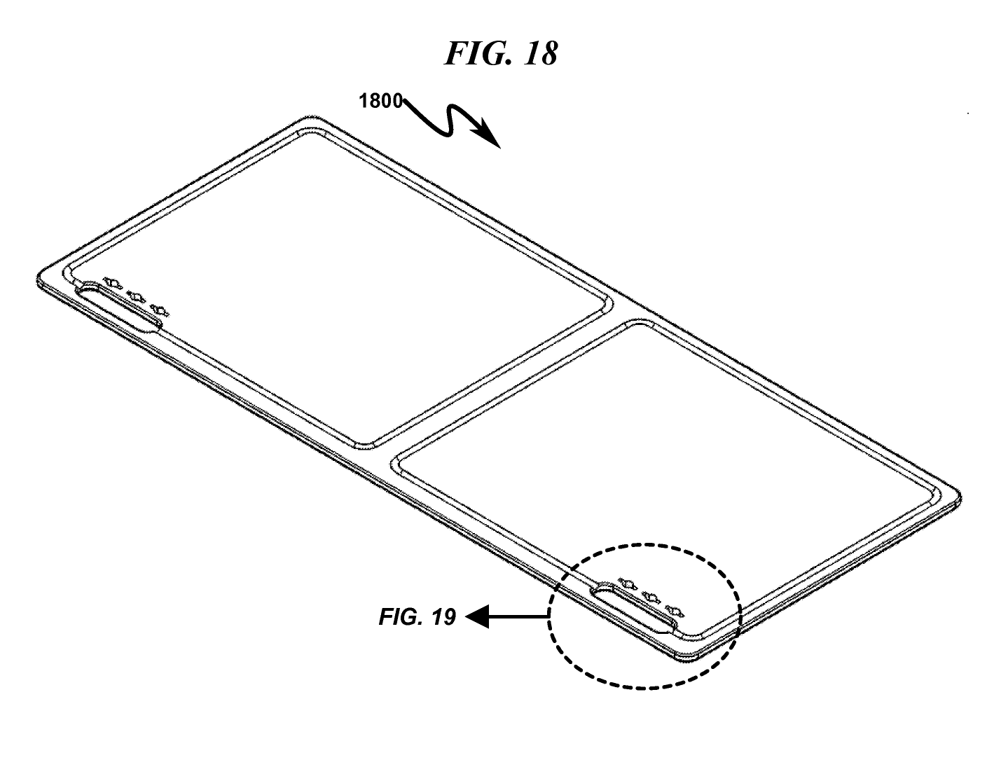

FIG. 19 illustrates a top perspective detail view of an alternate preferred exemplary invention embodiment incorporating separated food preparation surfaces;

FIG. 20 illustrates a horizontal sectional view of an alternate preferred exemplary invention embodiment incorporating separated food preparation surfaces;

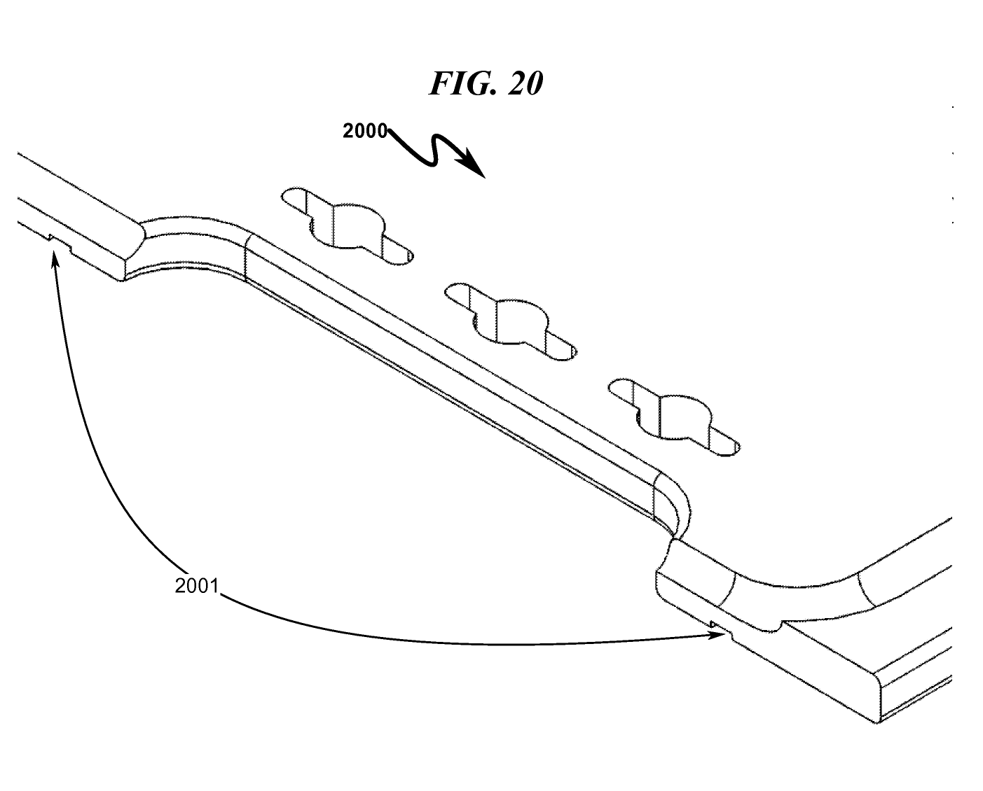

FIG. 21 illustrates a bottom view of an alternate preferred exemplary invention embodiment incorporating separated food preparation surfaces;

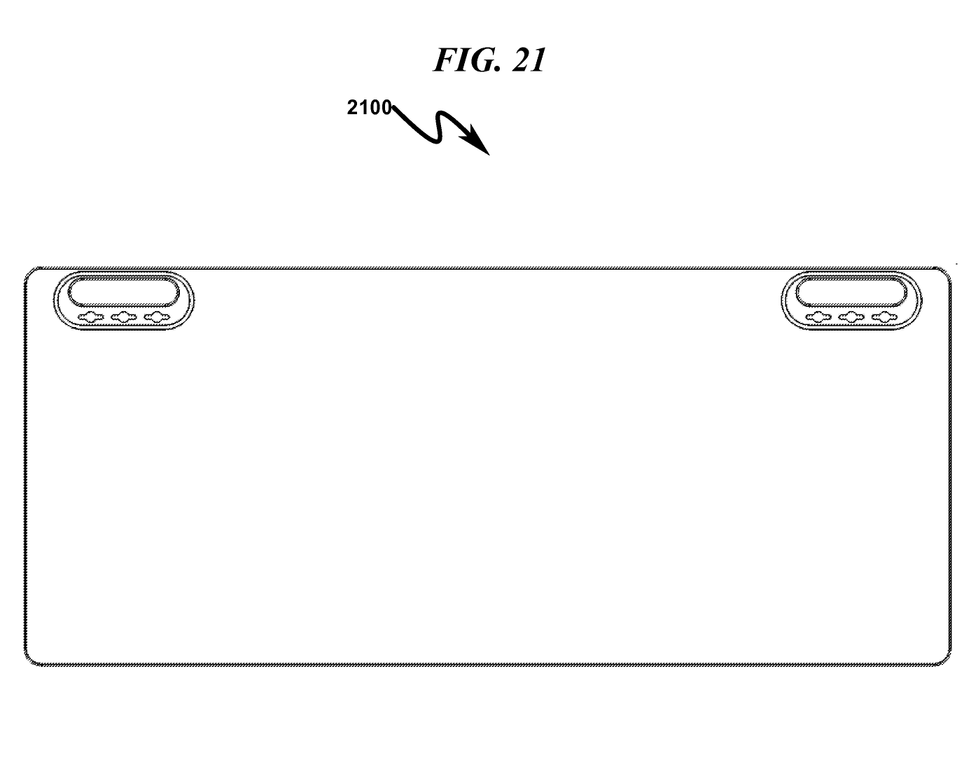

FIG. 22 illustrates a bottom perspective view of an alternate preferred exemplary invention embodiment incorporating separated food preparation surfaces;

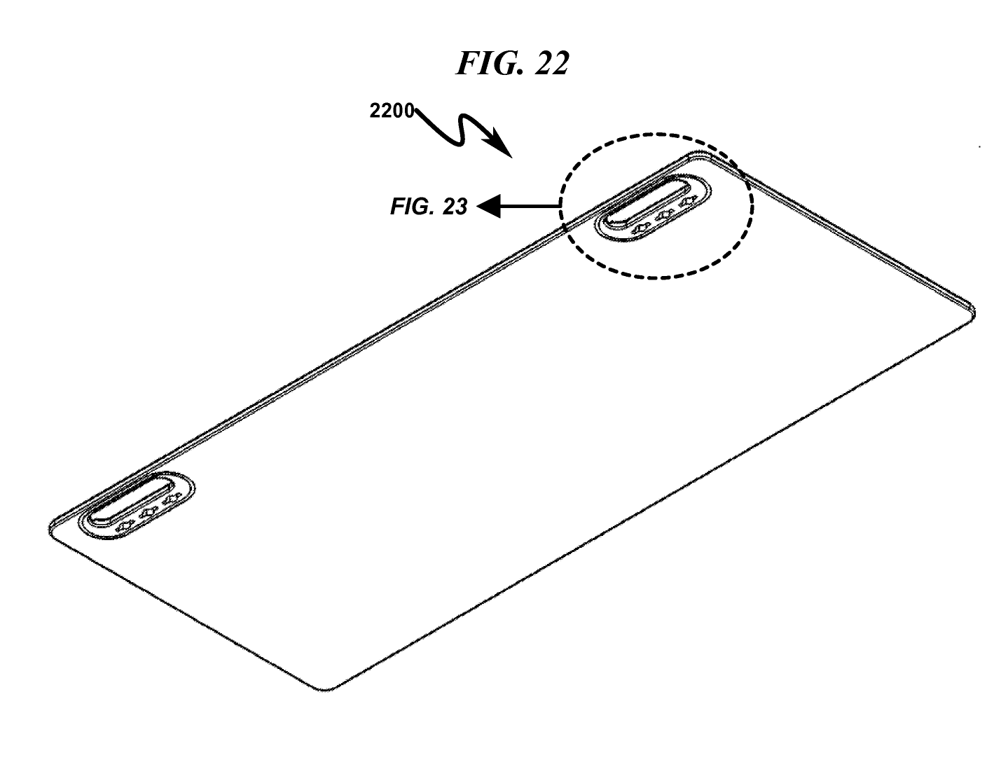

FIG. 23 illustrates a bottom perspective detail view of an alternate preferred exemplary invention embodiment incorporating separated food preparation surfaces;

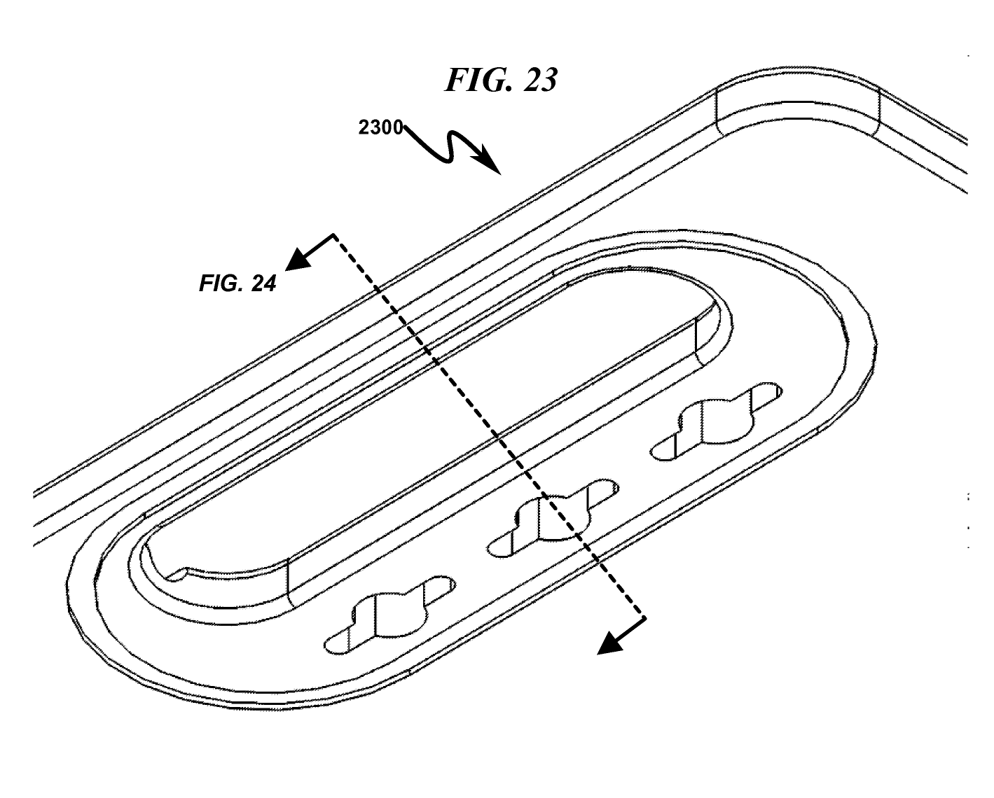

FIG. 24 illustrates a vertical sectional view of an alternate preferred exemplary invention embodiment incorporating separated food preparation surfaces;

FIG. 25 illustrates a top view of an alternate preferred exemplary invention embodiment incorporating tailgate cable retention slots;

FIG. 26 illustrates a top perspective view of an alternate preferred exemplary invention embodiment incorporating tailgate cable retention slots;

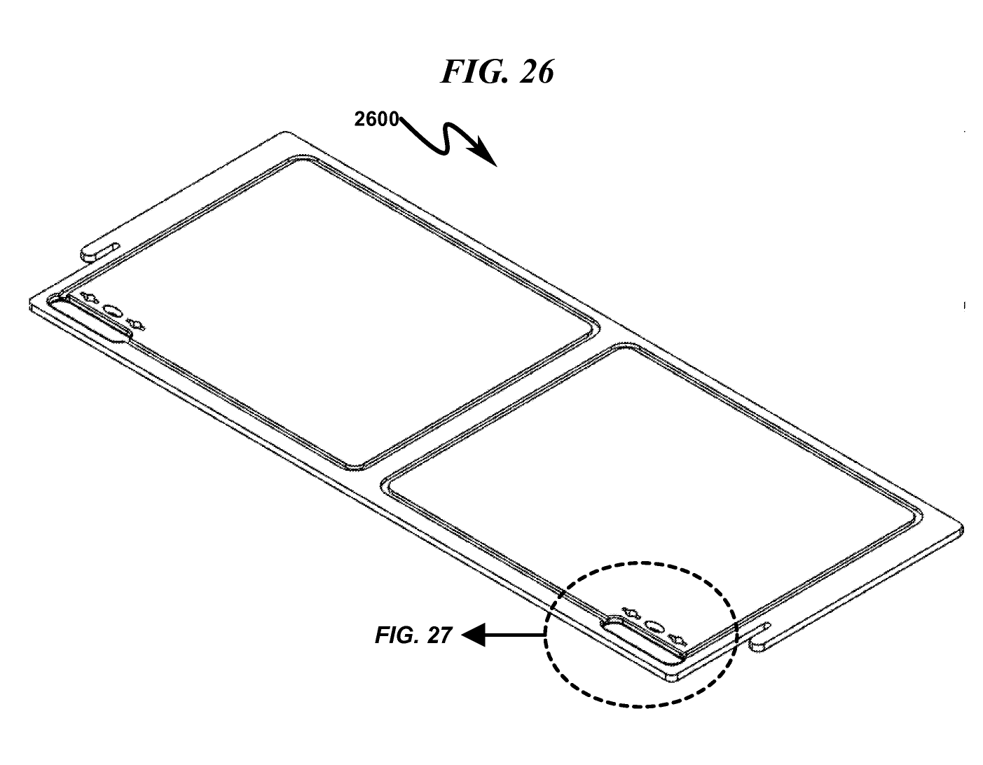

FIG. 27 illustrates a top perspective detail view of an alternate preferred exemplary invention embodiment incorporating tailgate cable retention slots;

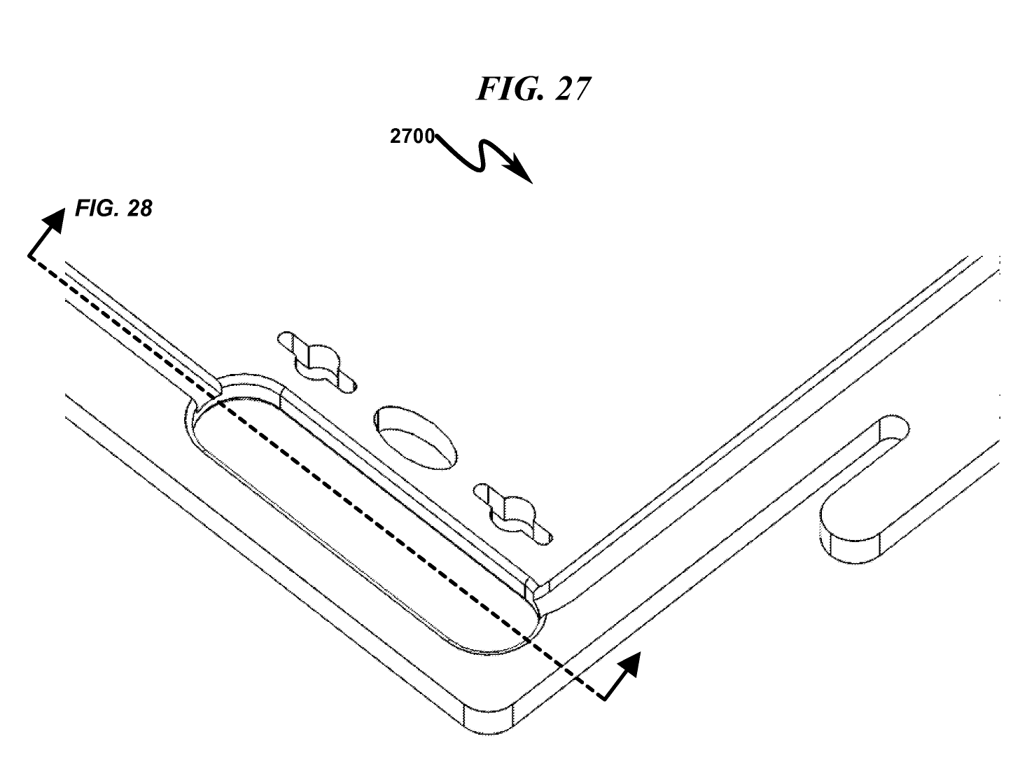

FIG. 28 illustrates a horizontal sectional view of an alternate preferred exemplary invention embodiment incorporating tailgate cable retention slots;

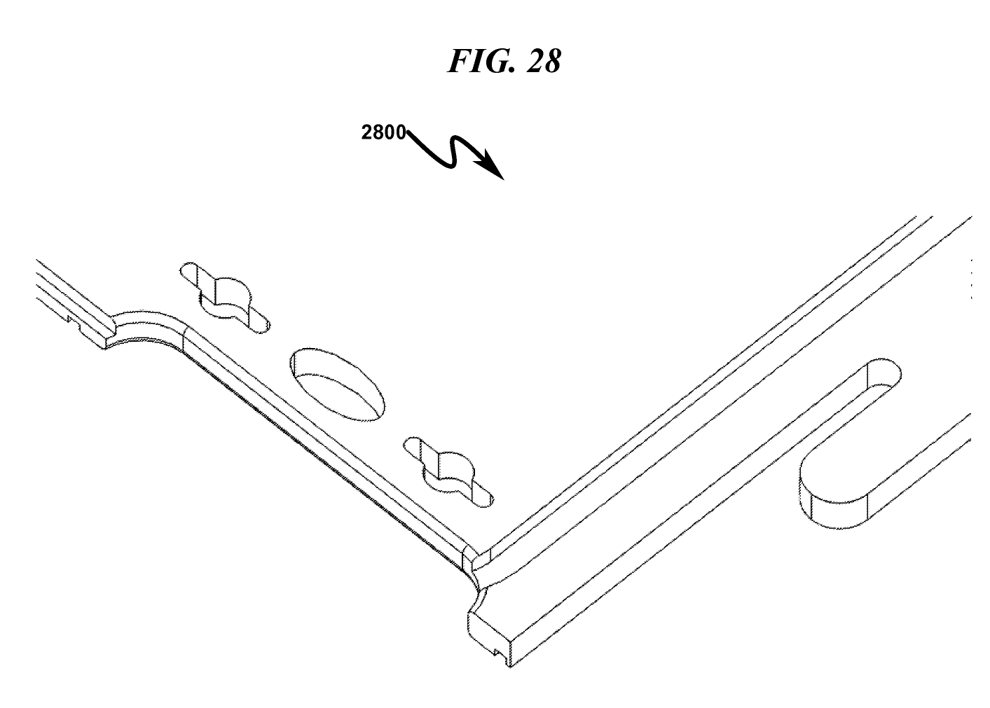

FIG. 29 illustrates a bottom view of an alternate preferred exemplary invention embodiment incorporating tailgate cable retention slots;

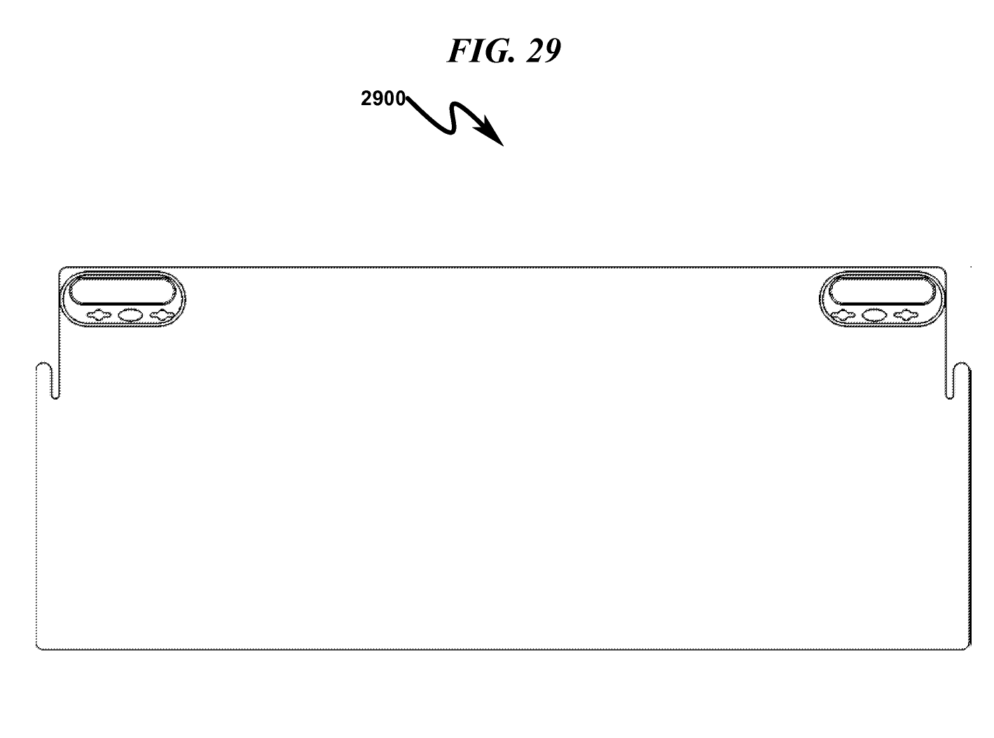

FIG. 30 illustrates a bottom perspective view of an alternate preferred exemplary invention embodiment incorporating tailgate cable retention slots;

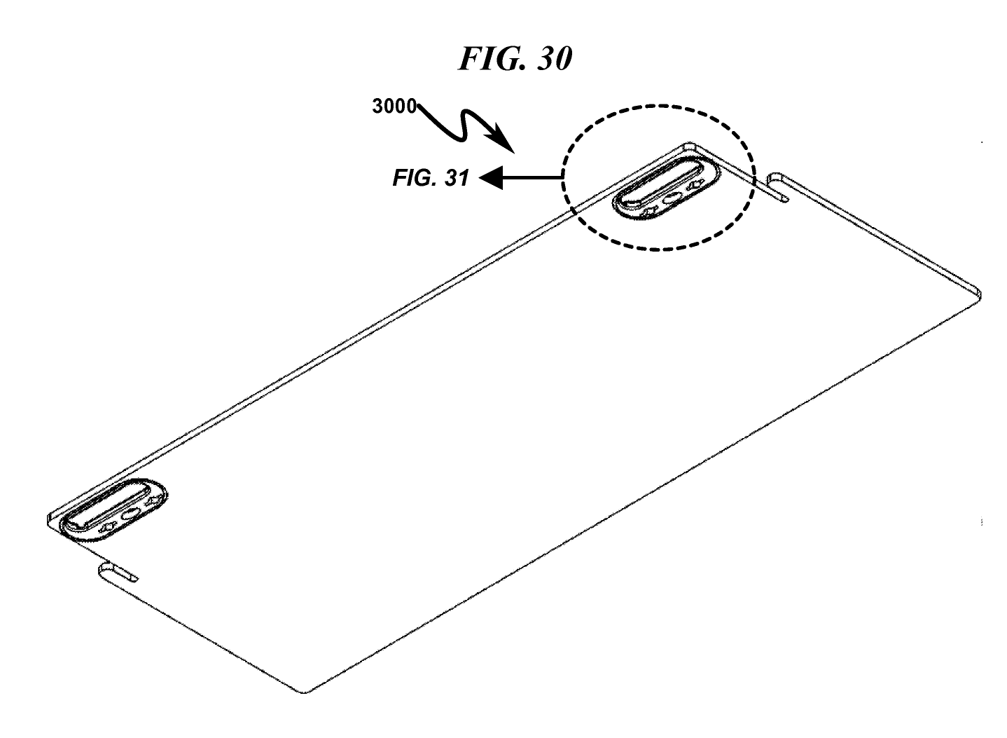

FIG. 31 illustrates a bottom perspective detail view of an alternate preferred exemplary invention embodiment incorporating tailgate cable retention slots;

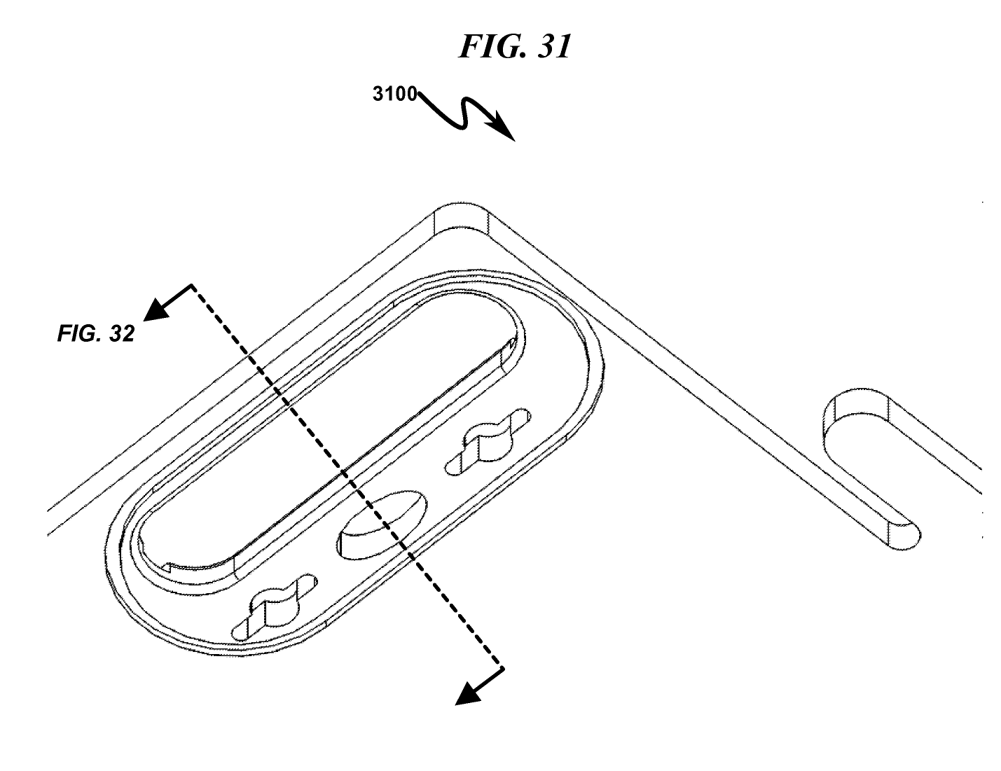

FIG. 32 illustrates a vertical sectional view of an alternate preferred exemplary invention embodiment incorporating tailgate cable retention slots;

FIG. 33 illustrates a top view of an alternate preferred exemplary invention embodiment incorporating hinged assembly;

FIG. 34 illustrates a top perspective view of an alternate preferred exemplary invention embodiment incorporating hinged assembly;

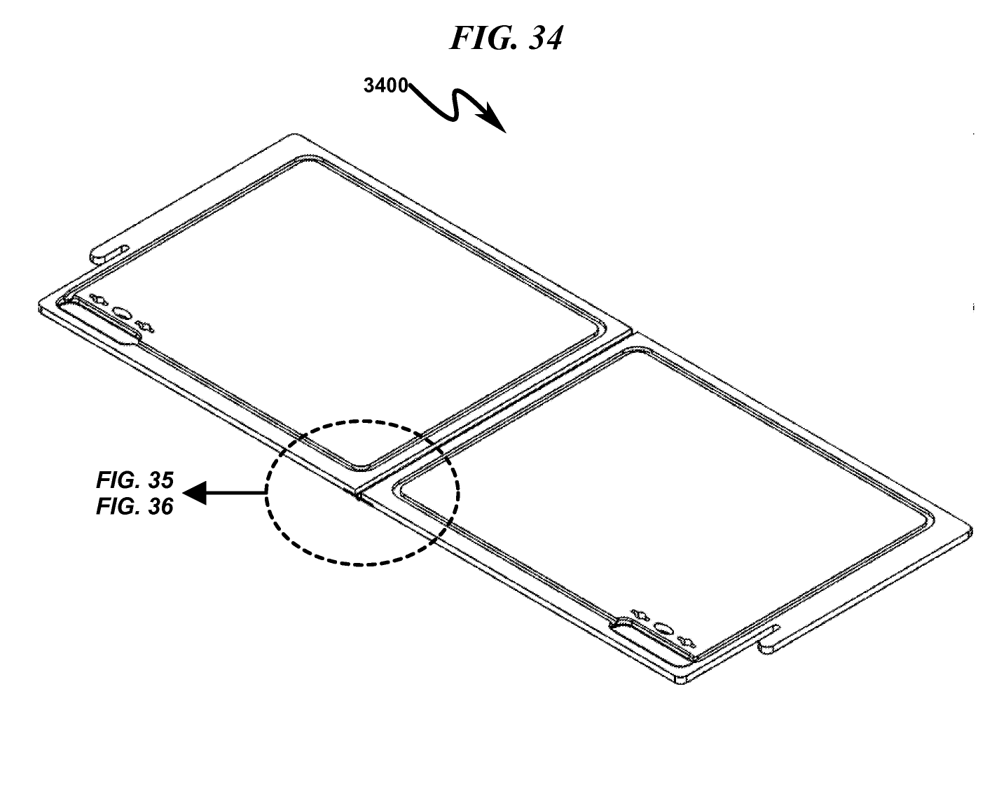

FIG. 35 illustrates a top perspective detail view of an alternate preferred exemplary invention embodiment incorporating hinged assembly;

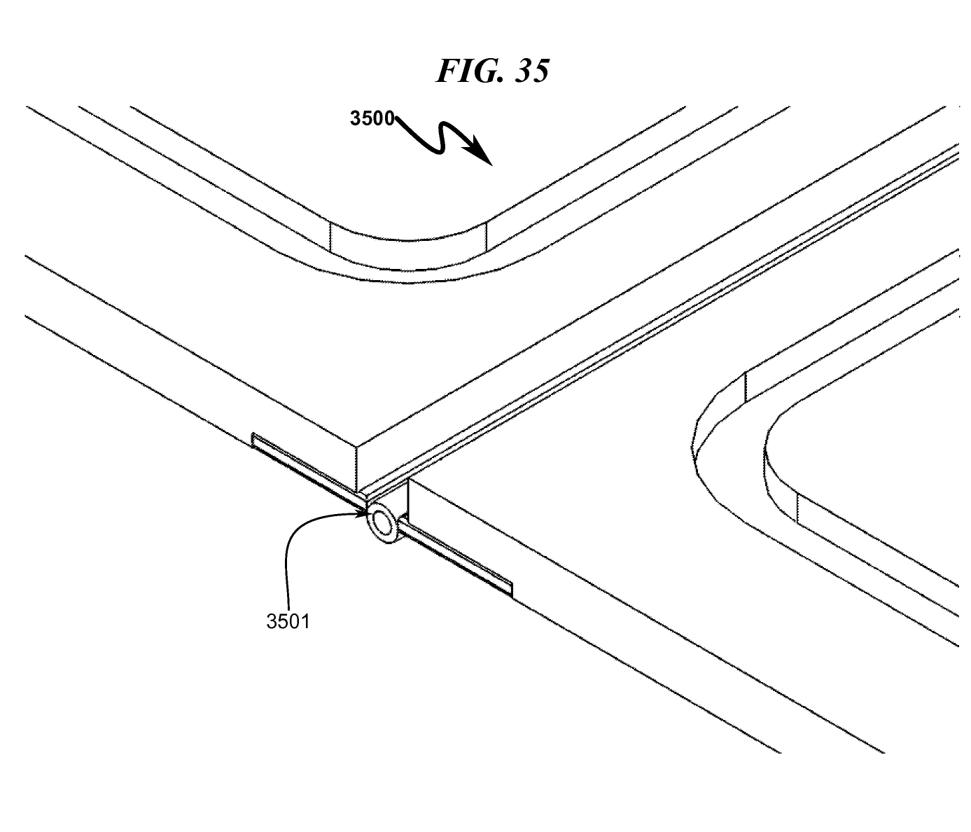

FIG. 36 illustrates a top perspective detail view of an alternate preferred exemplary invention embodiment incorporating hinged assembly;

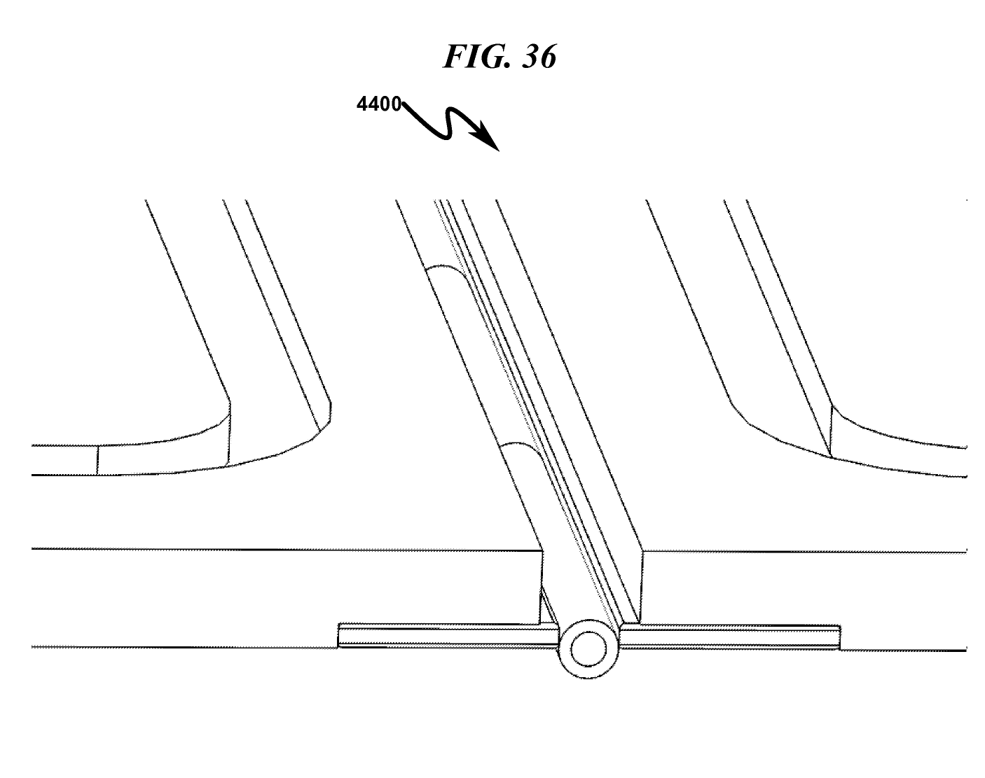

FIG. 37 illustrates a bottom view of an alternate preferred exemplary invention embodiment incorporating hinged assembly;

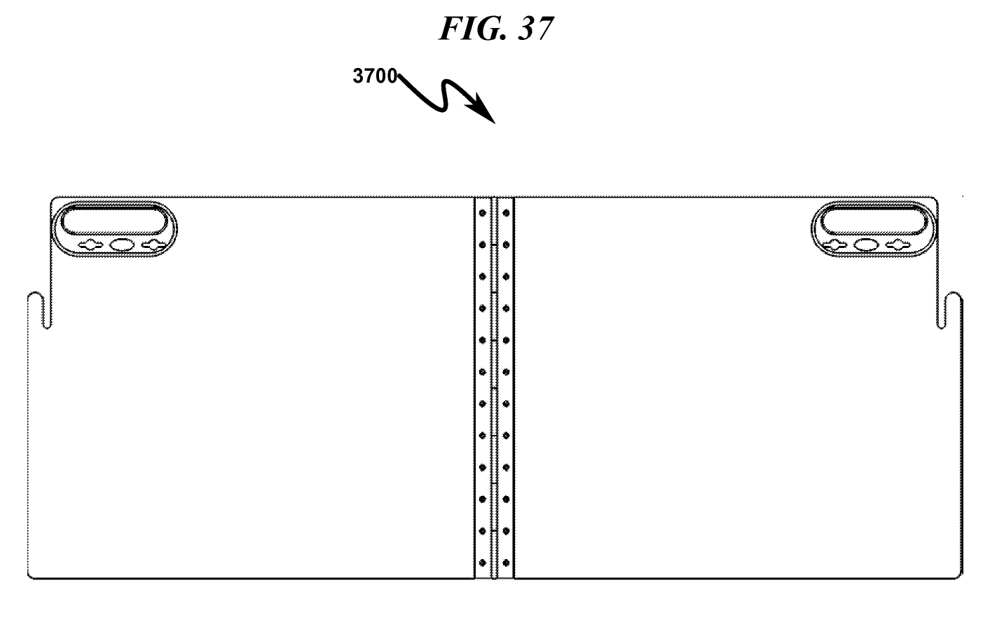

FIG. 38 illustrates a bottom perspective view of an alternate preferred exemplary invention embodiment incorporating hinged assembly;

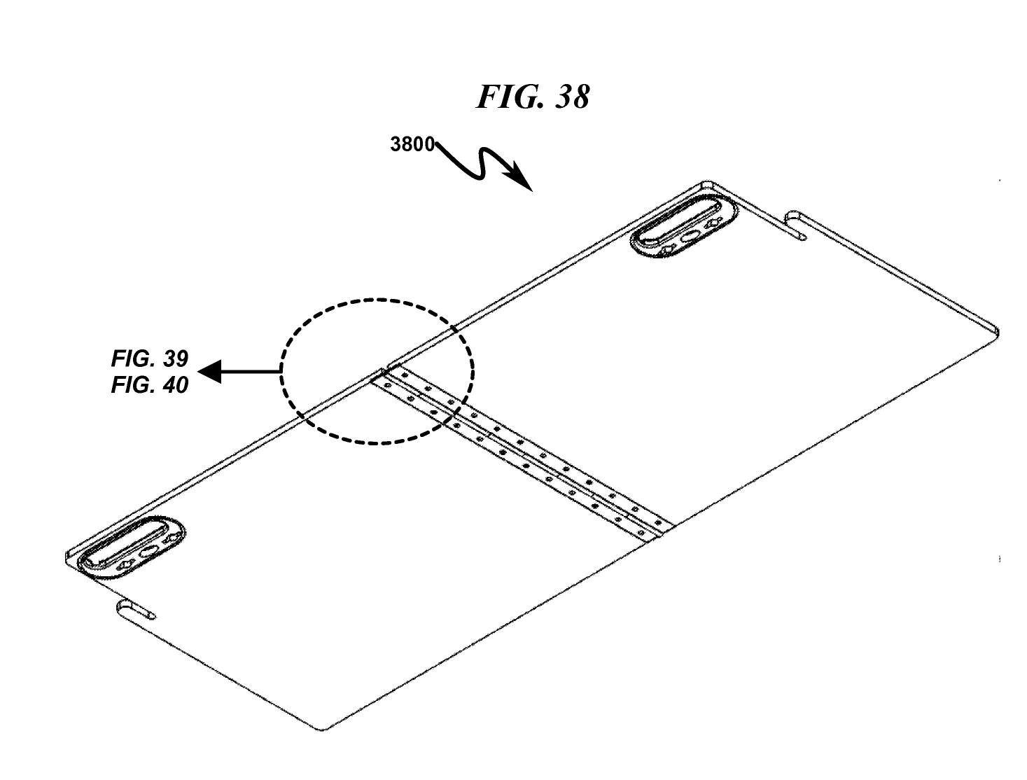

FIG. 39 illustrates a bottom perspective detail view of an alternate preferred exemplary invention embodiment incorporating hinged assembly;

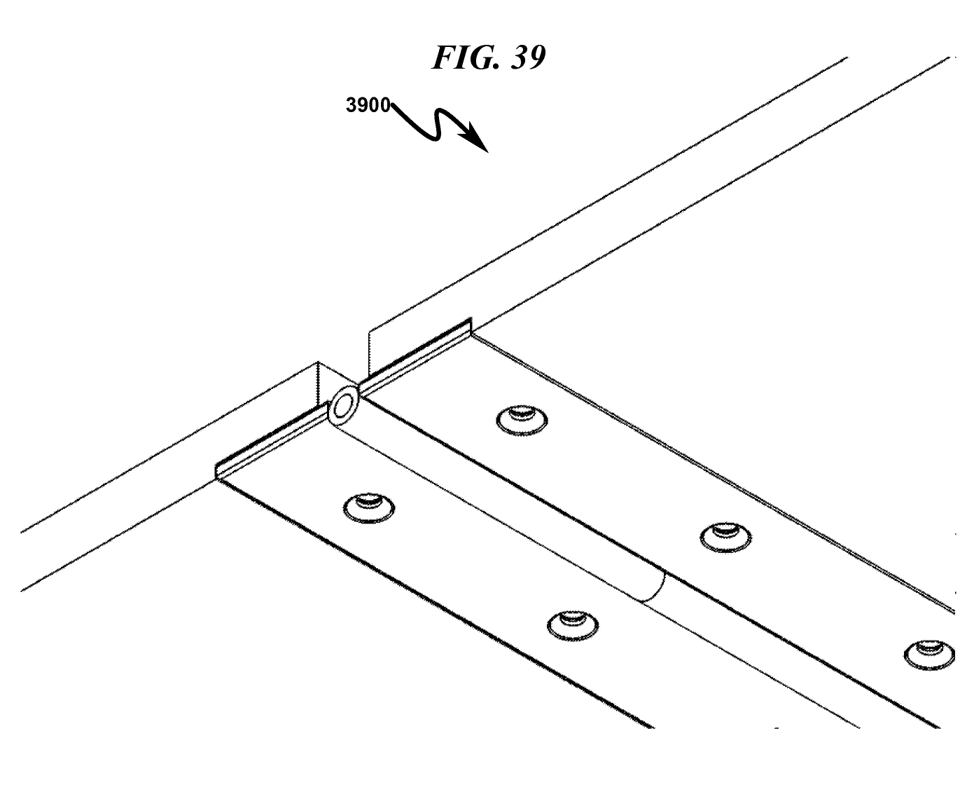

FIG. 40 illustrates a bottom perspective detail view of an alternate preferred exemplary invention embodiment incorporating hinged assembly;

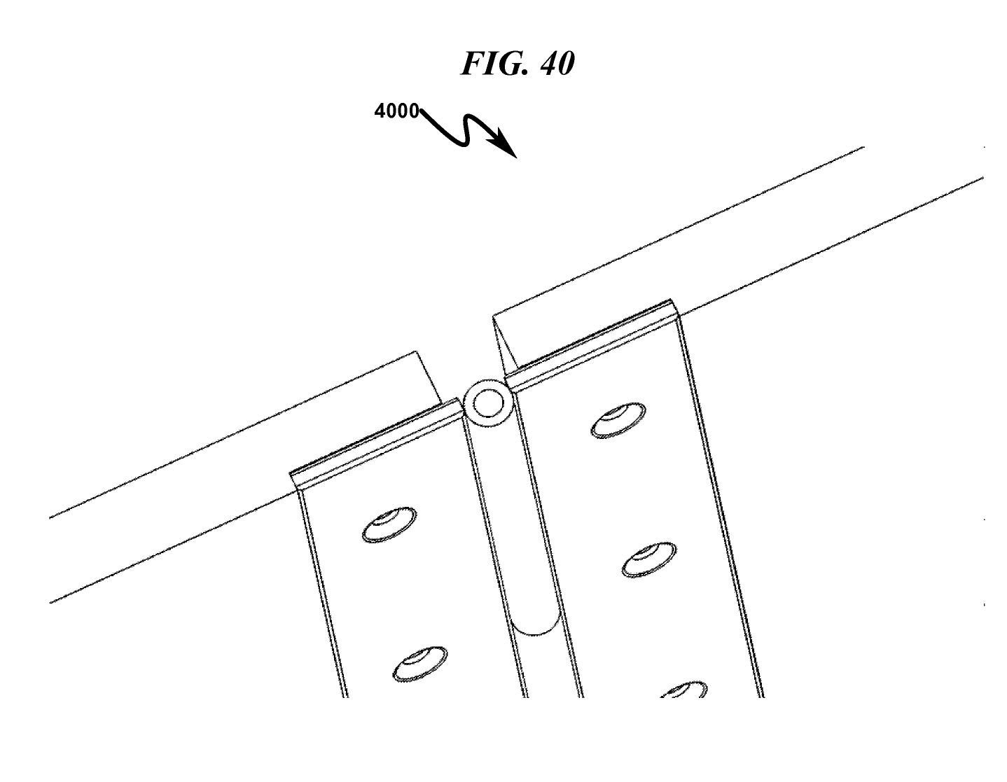

FIG. 41 illustrates a perspective view of an alternate preferred exemplary invention embodiment incorporating hinged assembly viewed as slightly folded in a first state;

FIG. 42 illustrates a perspective view of an alternate preferred exemplary invention embodiment incorporating hinged assembly viewed as slightly folded in a second state;

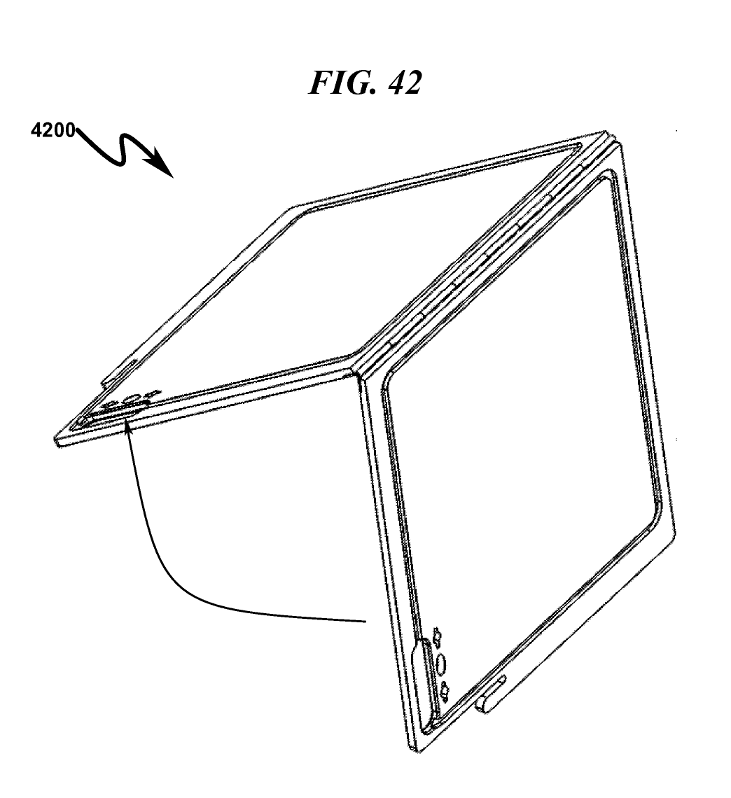

FIG. 43 illustrates a perspective view of an alternate preferred exemplary invention embodiment incorporating hinged assembly viewed as folded in a third state;

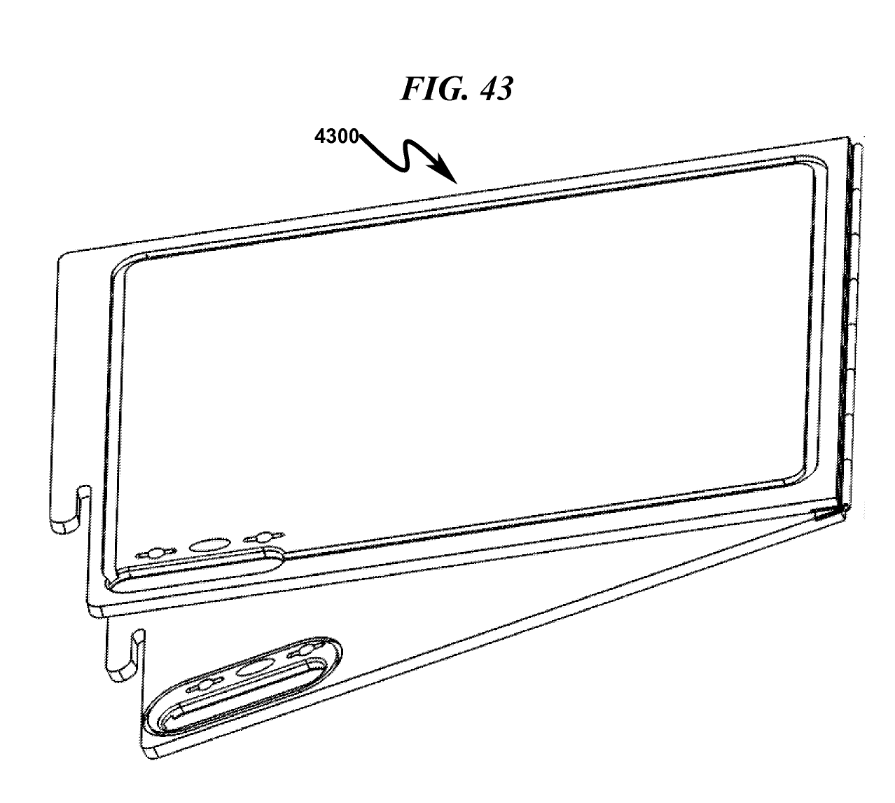

FIG. 44 illustrates a perspective view of an alternate preferred exemplary invention embodiment incorporating hinged assembly viewed as folded in a fourth state;

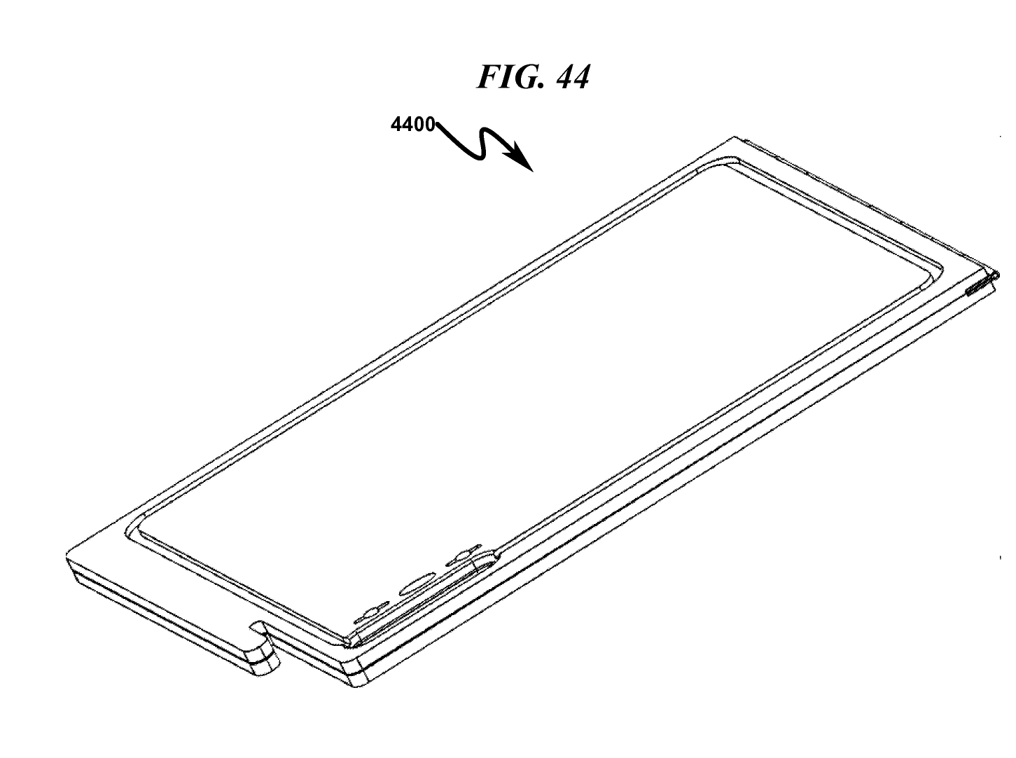

FIG. 45 illustrates a top perspective view of an alternate preferred exemplary invention embodiment incorporating hinged assembly mated to a tailgate and retained by tailgate support cables;

FIG. 46 illustrates a top detail perspective view of an alternate preferred exemplary invention embodiment incorporating hinged assembly mated to a tailgate and retained by tailgate support cables;

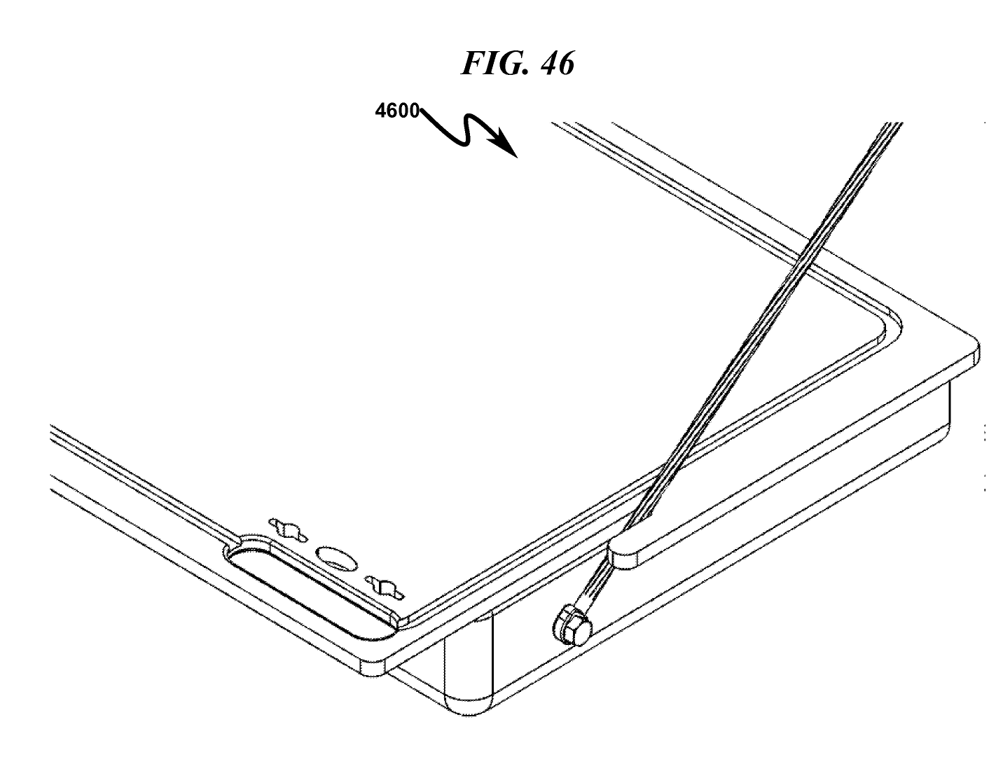

FIG. 47 illustrates a bottom perspective view of an alternate preferred exemplary invention embodiment incorporating hinged assembly mated to a tailgate and retained by tailgate support cables;

FIG. 48 illustrates a bottom detail perspective view of an alternate preferred exemplary invention embodiment incorporating hinged assembly mated to a tailgate and retained by tailgate support cables;

FIG. 49 illustrates a top perspective view of an alternate preferred exemplary invention embodiment incorporating a drainage port supporting an optional drainpipe;

FIG. 50 illustrates a top perspective detail view of an alternate preferred exemplary invention embodiment incorporating a drainage port supporting an optional drainpipe;

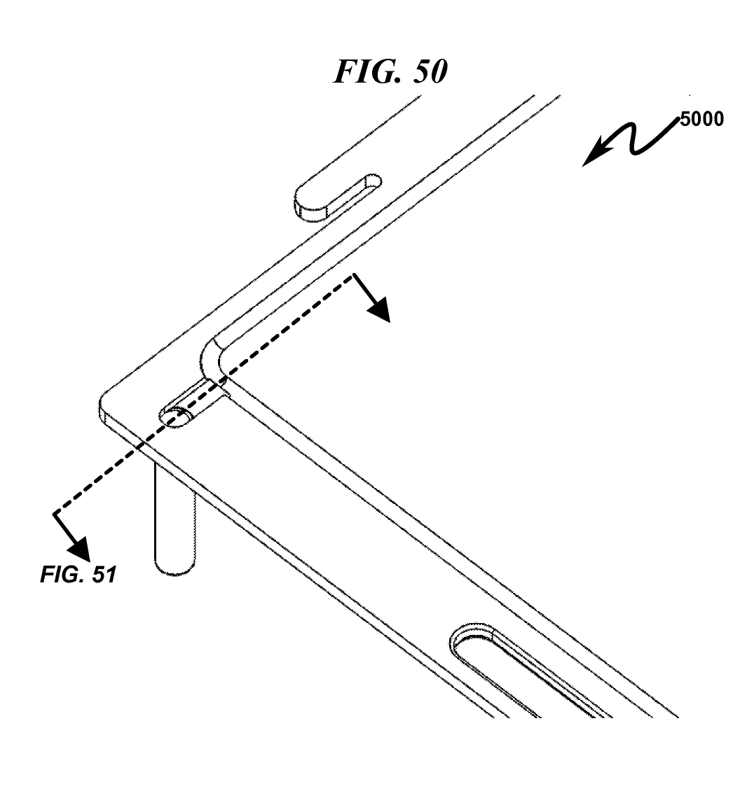

FIG. 51 illustrates a sectional view of an alternate preferred exemplary invention embodiment incorporating a drainage port supporting an optional drainpipe;

FIG. 52 illustrates a bottom perspective detail view of an alternate preferred exemplary invention embodiment incorporating a drainage port supporting an optional drainpipe;

FIG. 53 illustrates a top perspective view of an alternate preferred exemplary invention embodiment incorporating an edge-based drainage port;

FIG. 54 illustrates a top perspective detail view of an alternate preferred exemplary invention embodiment incorporating an edge-based drainage port;

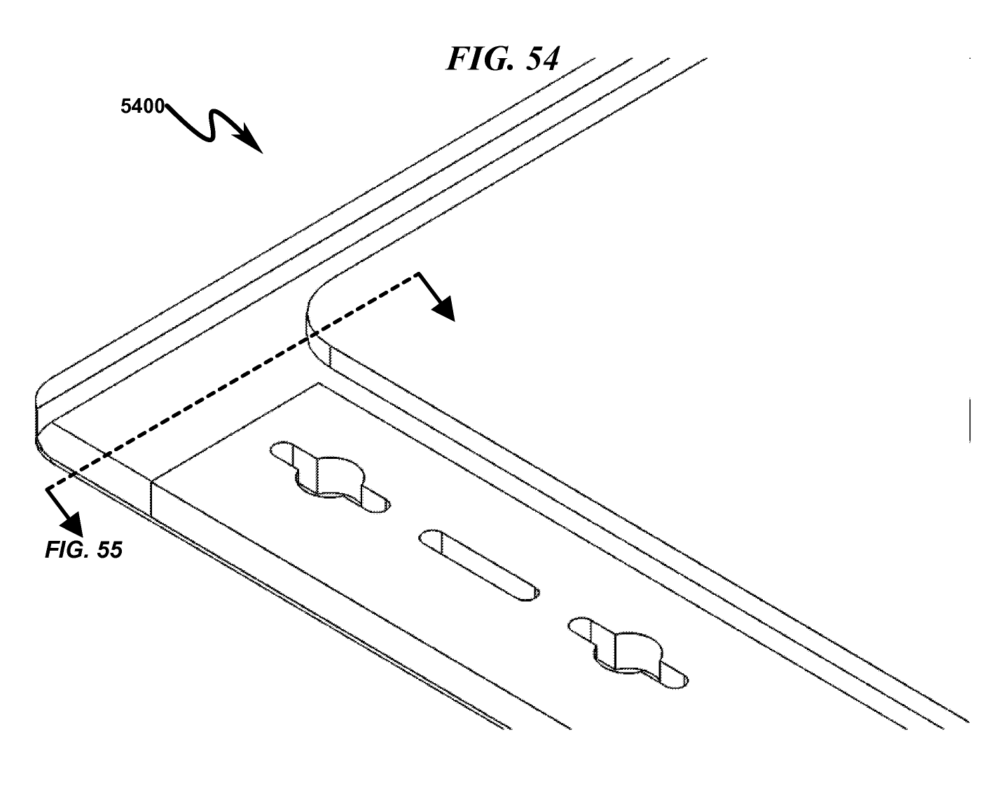

FIG. 55 illustrates a sectional view of an alternate preferred exemplary invention embodiment incorporating an edge-based drainage port;

FIG. 56 illustrates a bottom perspective detail view of an alternate preferred exemplary invention embodiment incorporating an edge-based drainage port;

FIG. 57 illustrates a top perspective view of a preferred exemplary invention embodiment incorporating hinged construction as installed on a pickup truck tailgate;

FIG. 58 illustrates a top perspective detail view of a preferred exemplary invention embodiment incorporating hinged construction as installed on a pickup truck tailgate;

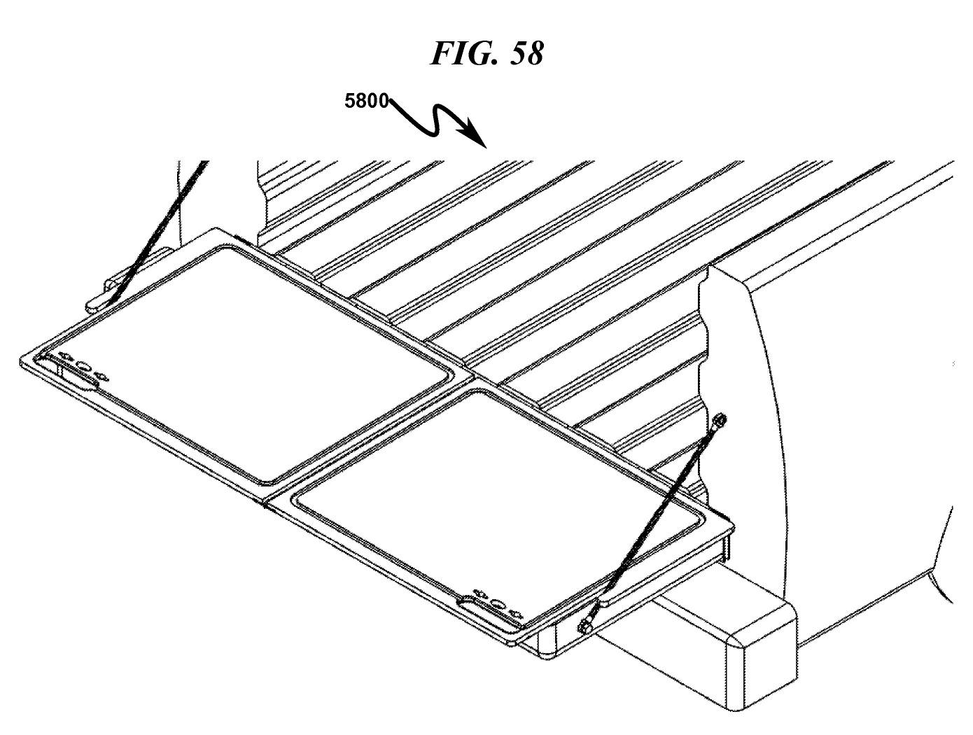

FIG. 59 illustrates a top perspective detail view of a preferred exemplary invention embodiment incorporating hinged construction as installed on a pickup truck tailgate and utilizing a waste receptacle for food preparation waste collection;

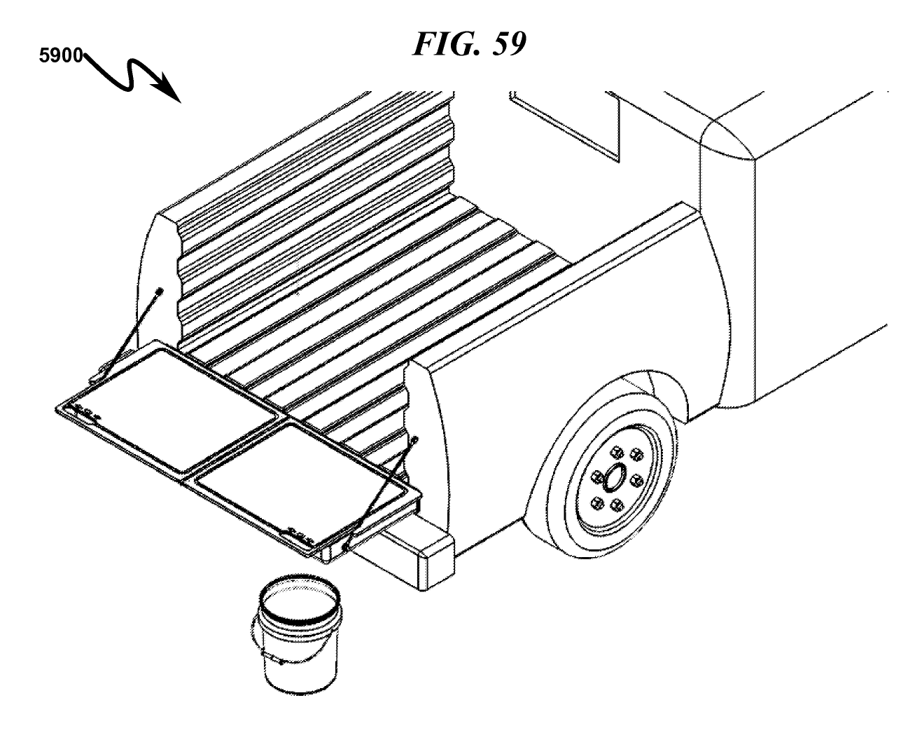

FIG. 60 illustrates a bottom perspective detail view of a preferred exemplary invention embodiment incorporating hinged construction as installed on a pickup truck tailgate;

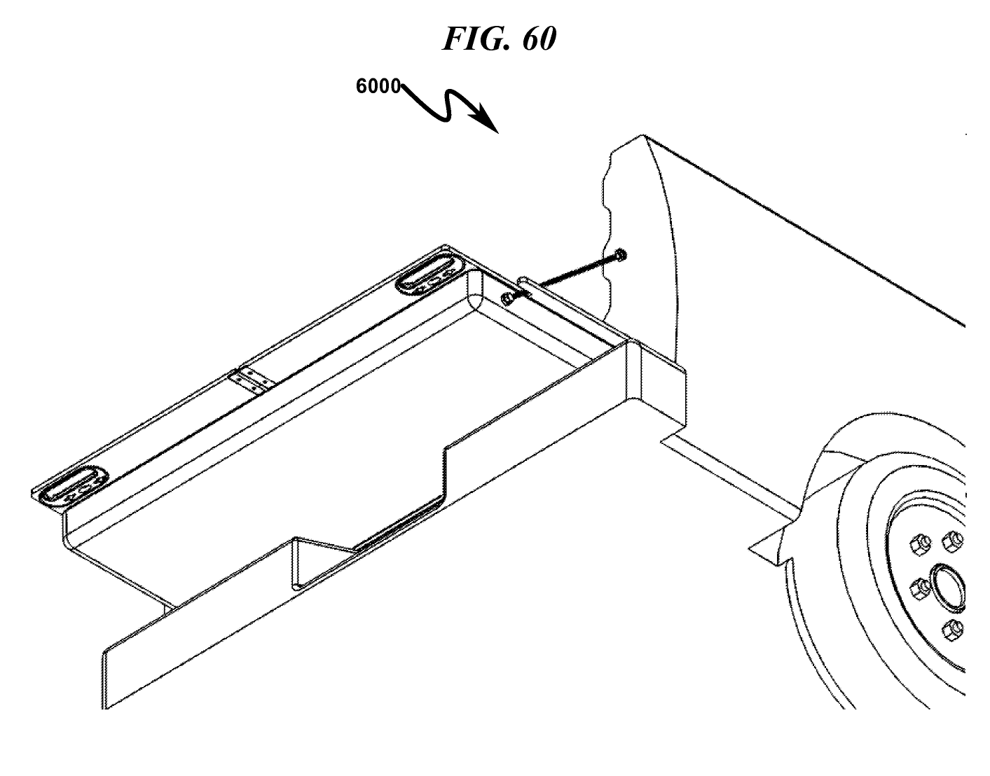

FIG. 61 illustrates a top perspective detail view of a preferred exemplary invention embodiment incorporating optional waste drainage pipe as installed on a pickup truck tailgate and utilizing a waste receptacle for food preparation waste collection;

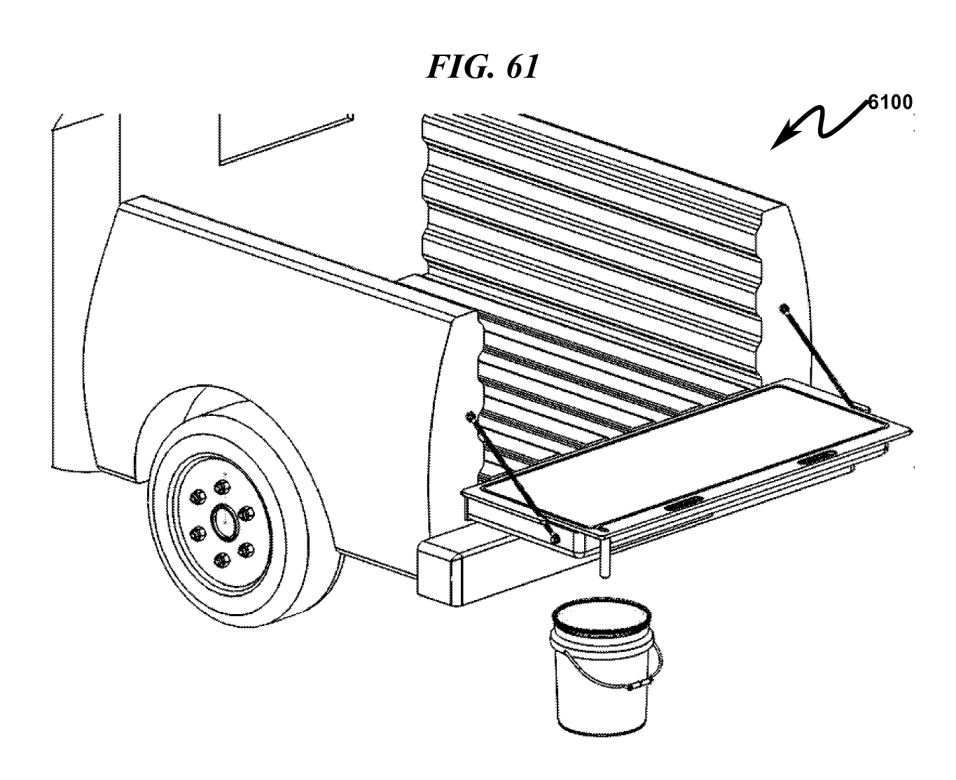

FIG. 62 illustrates a bottom perspective detail view of a preferred exemplary invention embodiment incorporating optional waste drainage pipe as installed on a pickup truck tailgate;

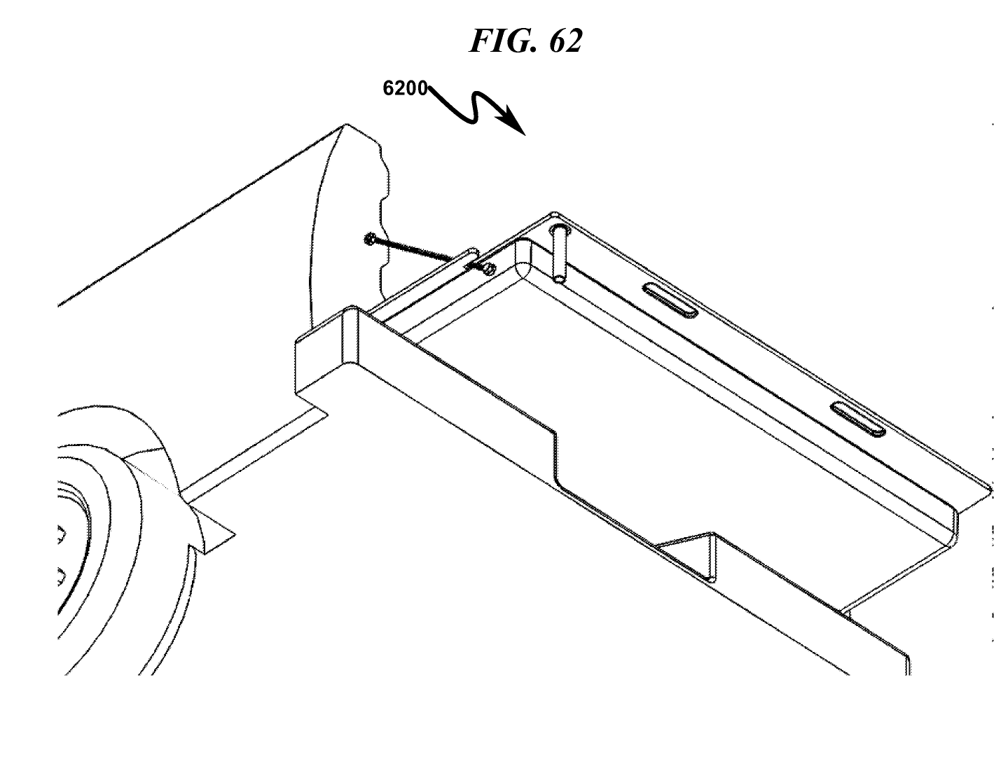

FIG. 63 illustrates a top perspective detail view of a preferred exemplary invention embodiment incorporating edge waste drainage as installed on a pickup truck tailgate and utilizing a waste receptacle for food preparation waste collection; and

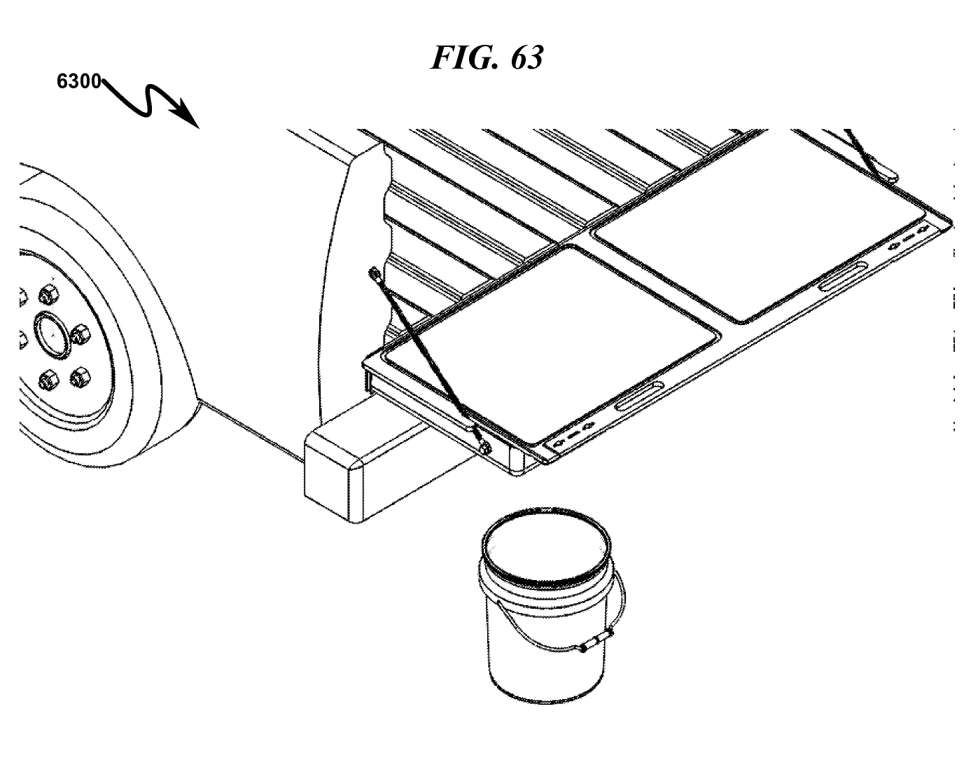

FIG. 64 illustrates a bottom perspective detail view of a preferred exemplary invention embodiment incorporating edge waste drainage as installed on a pickup truck tailgate.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a FOOD PREPARATION SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### System Overview

The present invention in various embodiments addresses one or more of the above objectives in the following manner:
A peripheral drainage system is incorporated that channels waste products associated with food preparation to collection ports in the cutting board that are configured with drainage lips. These drainage lips make use of the surface tension of the waste material to collect these products in a localized fashion to prevent contamination of the tailgate or other items not associated with the cutting board.
The peripheral drainage system may be combined with the use of handles used to load/manipulate the cutting board, thus forming an integrated lifting/drainage system for the food preparation system.
In some applications the food preparation system may be used to prepare both meat and non-meat products and as such separate drainage systems and food preparation areas may be configured to isolate the meat/non-meat preparation areas to ensure sanitary conditions are maintained within the context of the overall food preparation system.
The food preparation system may be configured to provide carrying handles as indicated above but also storage slots for knives and other food preparation tools. This feature is important to isolate food preparation tools that are used for meat/non-meat preparation.
The food preparation system may be configured with tailgate engagement slots positioned to retain the system to a pickup tailgate using the existing tailgate chain/cable supports. These tailgate engagement slots may be configured to support passive or active engagement of the tailgate.

One skilled in the art will recognize that the various embodiments depicted herein may be combined to produce a variety of system configurations consistent with the teachings of the invention.

### Preferred Exemplary System Embodiment (0900)-(1600)

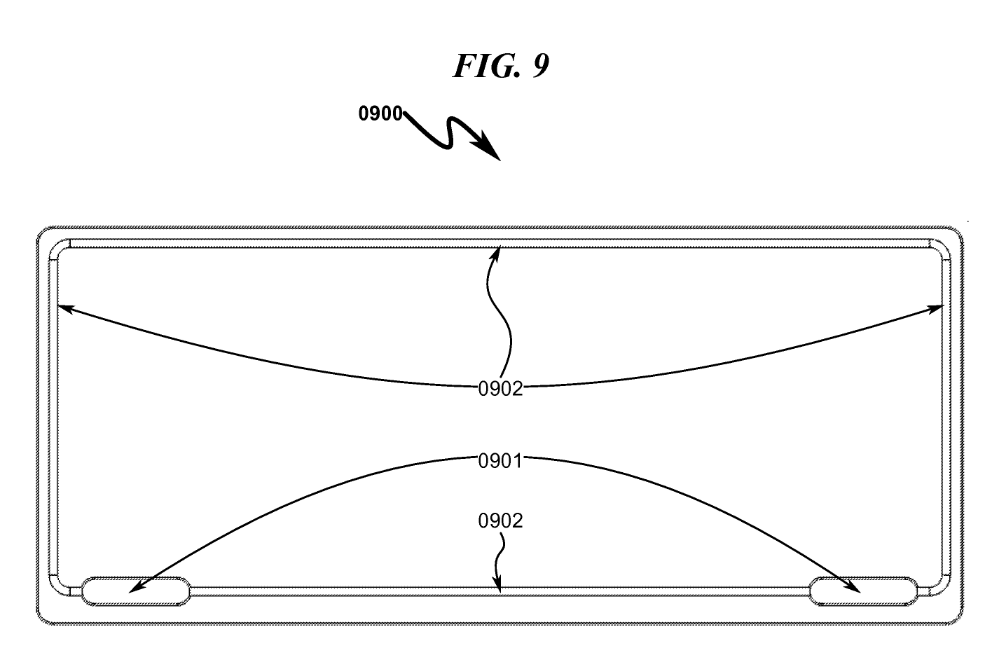

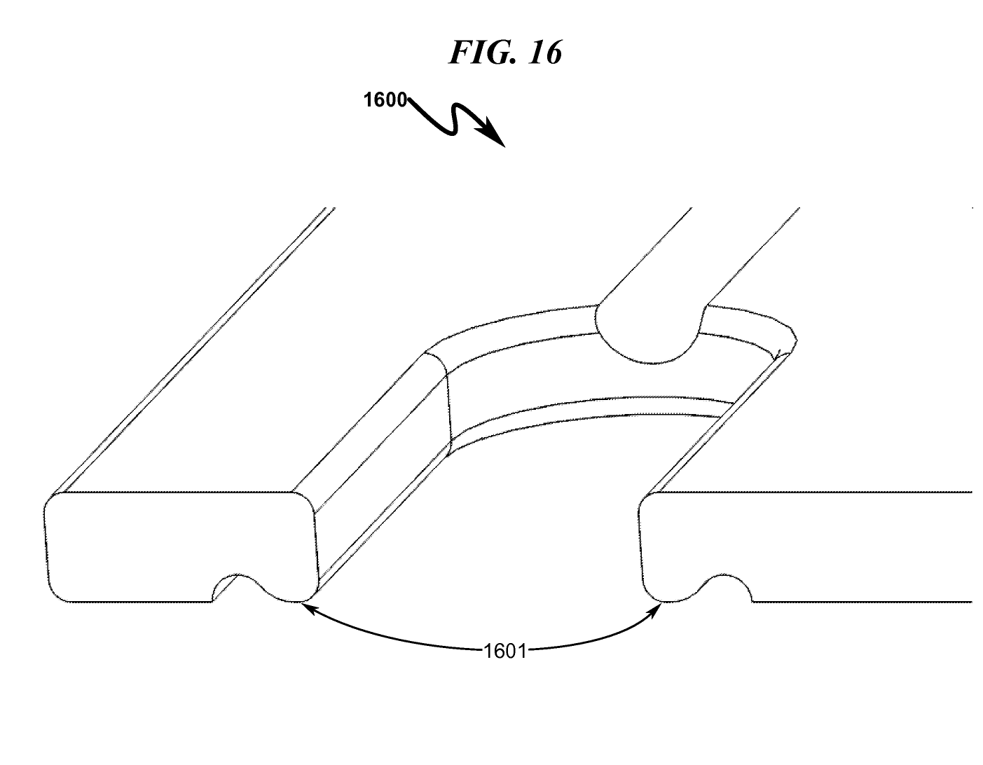

As generally illustrated in FIG. 9 (0900)-FIG. 16 (1600), a preferred exemplary invention system embodiment is constructed of a polymer, preferably high density polyethylene or acetyl) and is typically constructed to conform to the width dimensions of a pickup truck tailgate with a thickness on the order of ⅜-½ inch. The depth of the system is generally deeper than that of a pickup truck tailgate to ensure that the handles/draining ports extend over the edge of the pickup truck tailgate.

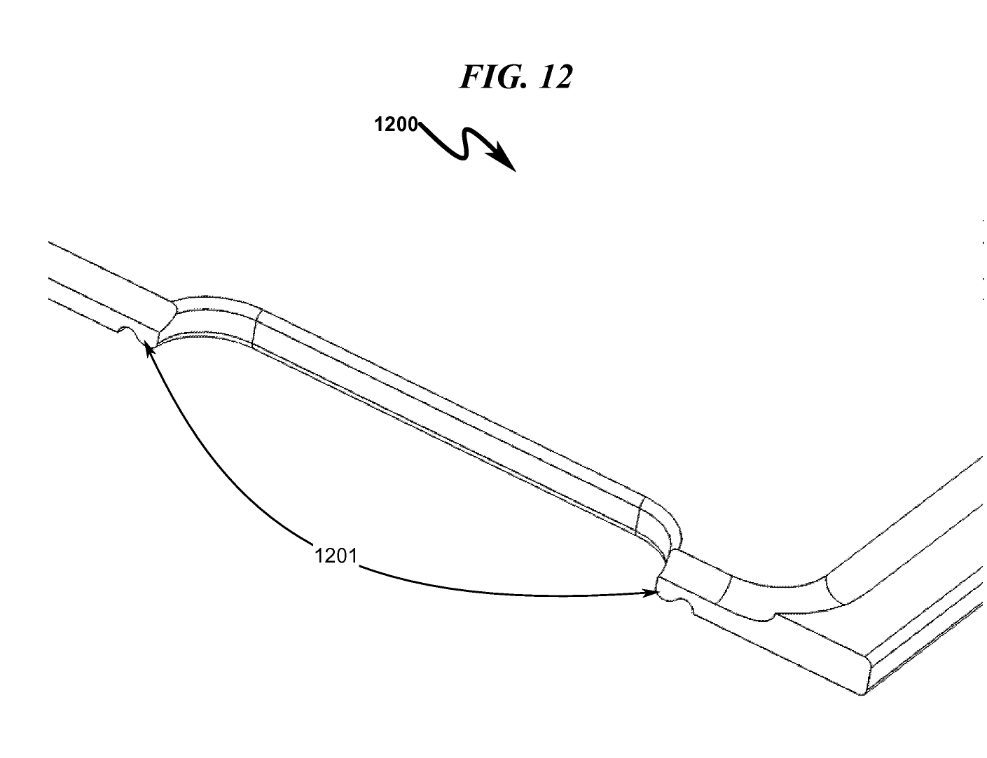

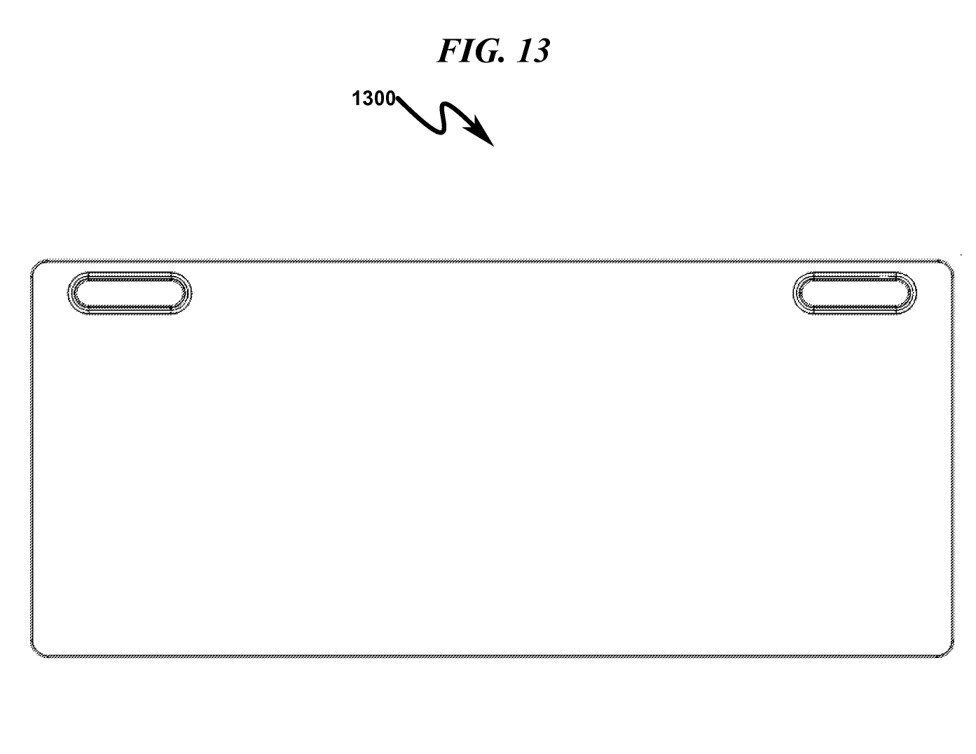

The top (FIG. 9 (0900)-FIG. 12 (1200)) and bottom (FIG. 13 (1300)-FIG. 16 (1600)) views of the system generally illustrate the integration of lifting handles (0901) with the peripheral waste collection channels (0902). The inner periphery of the system as illustrated further comprises a drainage groove (0902) milled/formed into the surface of the system that extends around the entire periphery and is collected in one or more of the drainage ports (0901). These drainage ports are constructed with a drainage lip on the bottom of the waste collection port to utilize the surface tension of the waste material to ensure that this material drips in an area localized to the waste collection port and does not contaminate the tailgate or disperse in a wide area around the tailgate. This permits the waste collection ports to be used in conjunction with a bucket or other collection device to collect waste without the need for special waste management controls.

As generally illustrated in the cross sectional views of FIG. 12 (1200) and FIG. 16 (1600), the drainage lips (1201, 1601) formed on the bottom of the system surface extend around the periphery of the waste collection ports and therefore localize the dripping of liquid waste from the peripheral waste collection grooves on the surface of the system. It should be noted that while the drainage lips are illustrated as curved surfaces, any surface profile capable of supporting a localized dripping action via use of the waste liquid surface tension is anticipated for this function.

### System Embodiment

### Separate Food Preparation (1700)-(2400)

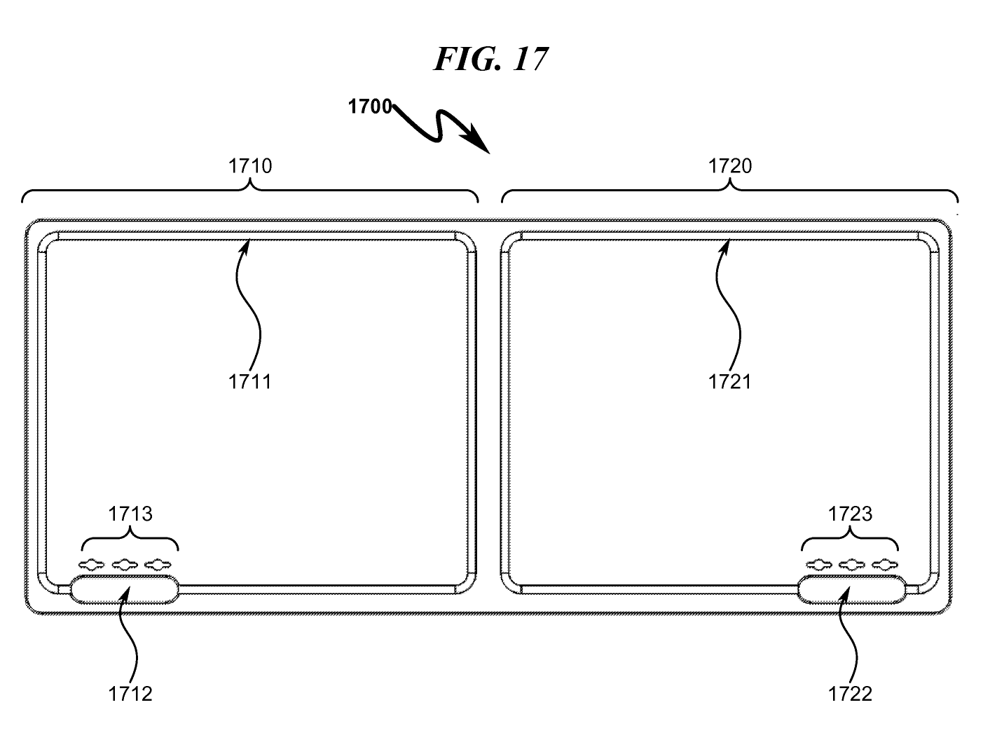

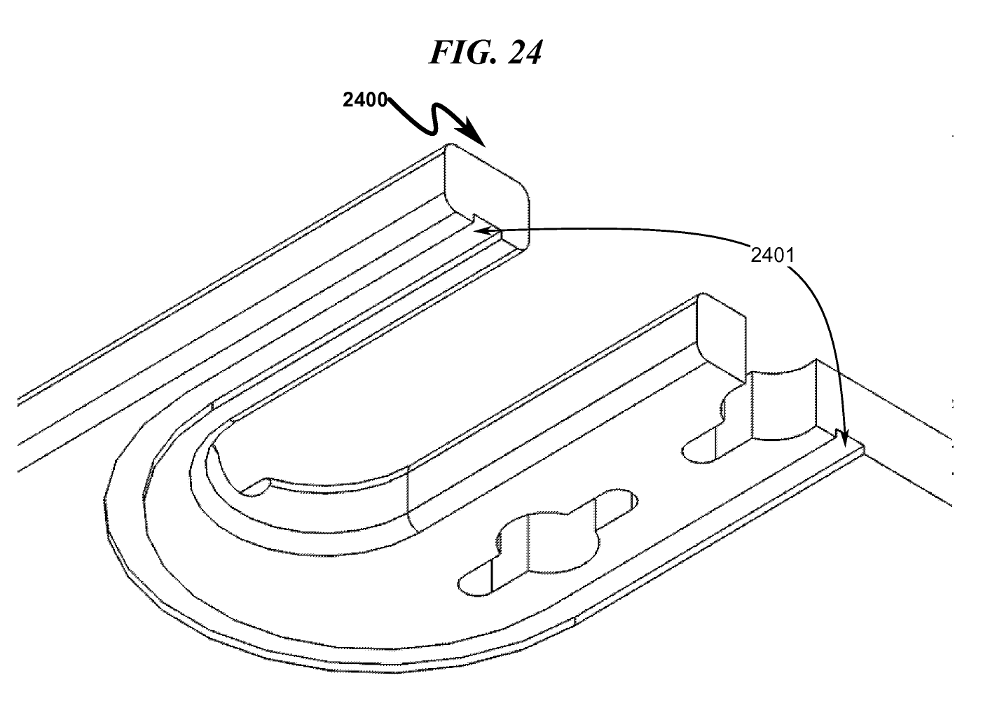

As generally illustrated in FIG. 17 (1700)-FIG. 24 (2400), an alternate preferred exemplary invention system embodiment may utilize separate food preparation areas (1710, 1720) that are isolated and have separate peripheral waste collection channels (1711, 1721) and separate waste drainage ports (1712, 1722). This embodiment also illustrates optional food preparation tool cutouts (1713, 1723) that permit knives, forks, and other food preparation tools to be stored separately in the system so as to prevent cross-contamination between the two sides (1710, 1720) of the food preparation surface.

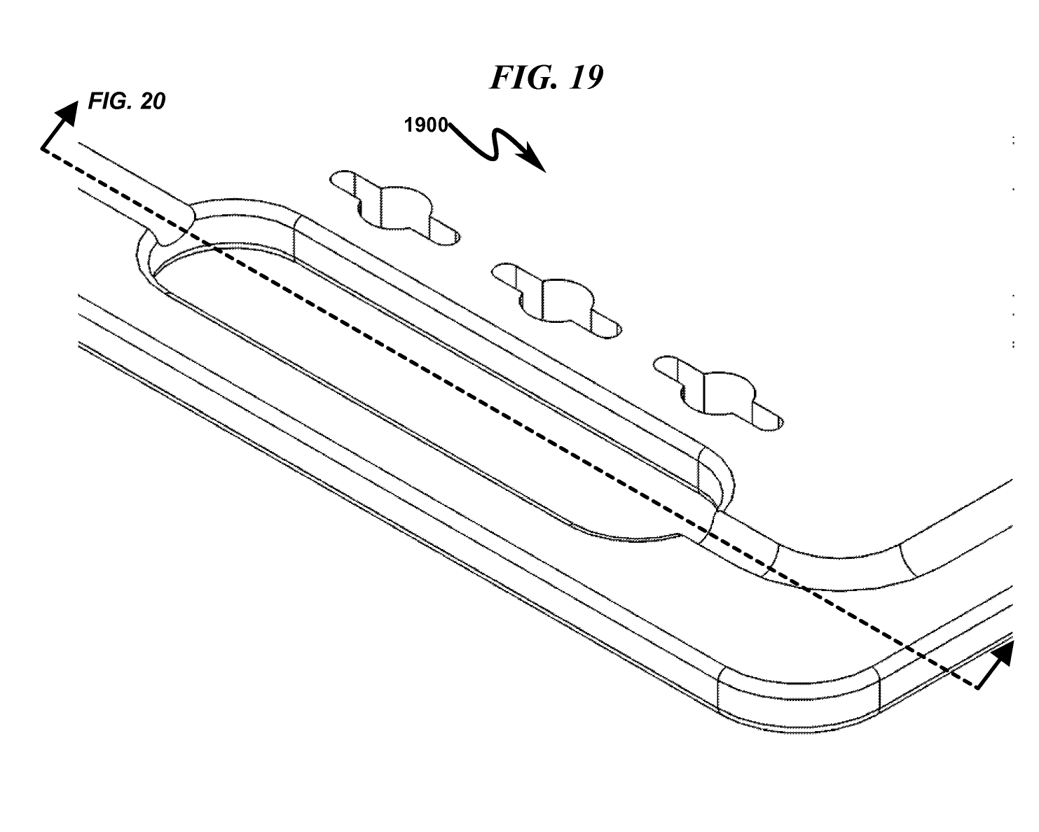

This particular preferred embodiment also illustrates that variation in the dripping lip is anticipated in the invention as generally depicted in the cross section views of FIG. 19 (2000) and FIG. 24 (2400). Here the drip edge is formed using a rectangular indentation (2001, 2401) in the bottom surface of the cutting surface that surrounds both the handle holes and the food preparation tool cutouts. As mentioned previously, the profile of the drip edge can vary based on application, and in this circumstance is simplified to encompass the handle holes and food preparation tool cutouts.

The ability to separate both food preparation and the tools used for this preparation is a significant feature of this particular embodiment as cross contamination results in thousands of deaths in the United States every year. By separating the food preparation surfaces, providing separate waste drainage ports, and separate storage for food preparation tools, there is less likelihood that the contamination of one pre-cook food preparation surface (1710) will result in contamination of the separate post-cook food preparation surface (1720).

### System Embodiment

### Tailgate Capture (2500)-(3200)

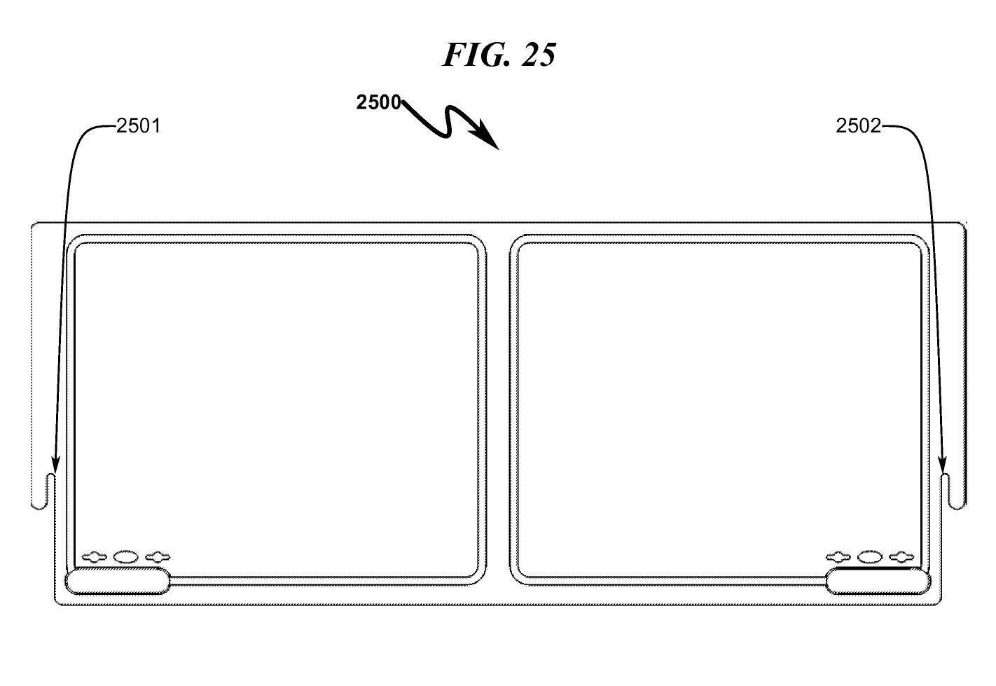

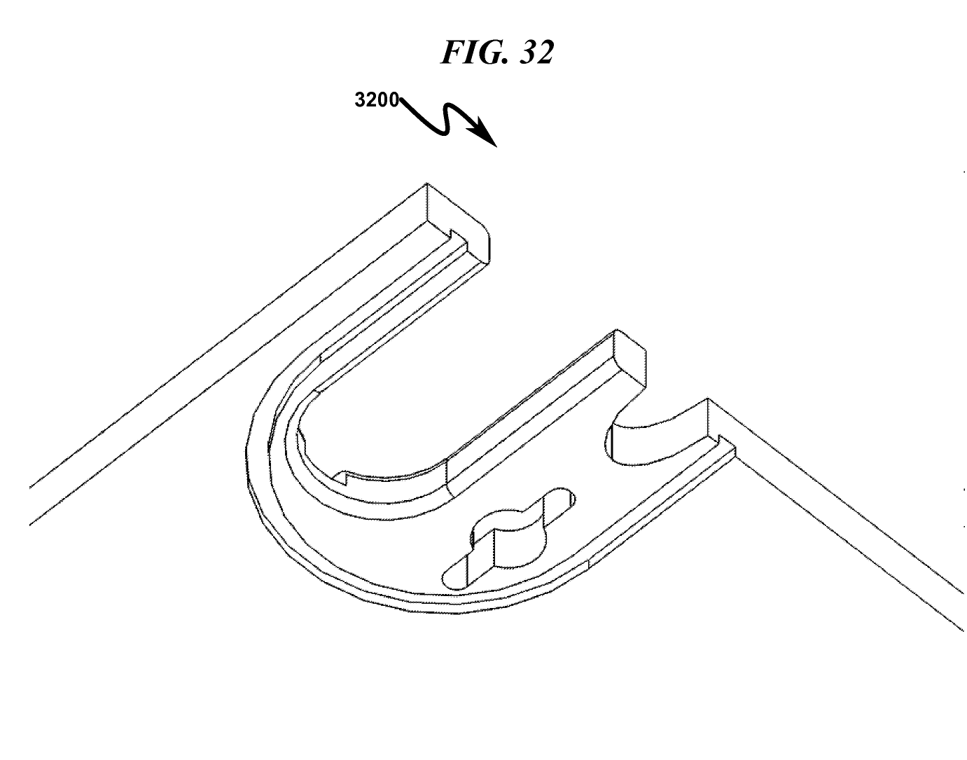

As generally illustrated in FIG. 25 (2500)-FIG. 32 (3200), an alternate preferred exemplary invention system embodiment may incorporate tailgate cable capture slots (2501, 2502) positioned at the side of the system to engage the support means of the tailgate. Typical pickup truck tailgates are supported in their horizontally deployed position using a wire cable or chain. The system configuration depicted in FIG. 25 (2500)-FIG. 32 (3200) incorporates cable/chain capture slots (2501, 2502) that engage the tailgate support means to prevent lateral movement of the cutting surface. Proper placement of the cable capture slots (2501, 2502) also forces the back end of the cutting surface against the pickup truck bed, thus securing the cutting surface in both X and Y horizontal axes of movement.

Also illustrated in this embodiment are variations in positioning of the handles as well as the use of rectangular waste disposal troughs along the periphery of the upper food preparation surface. A rectangular bottom drip isolation groove is also depicted to ensure that liquid waste exiting the handle slots does not contaminate the pickup truck tailgate and is properly deposited below the waste disposal handle holes.

### System Embodiment

### Folding Hinge (3300)-(4800)

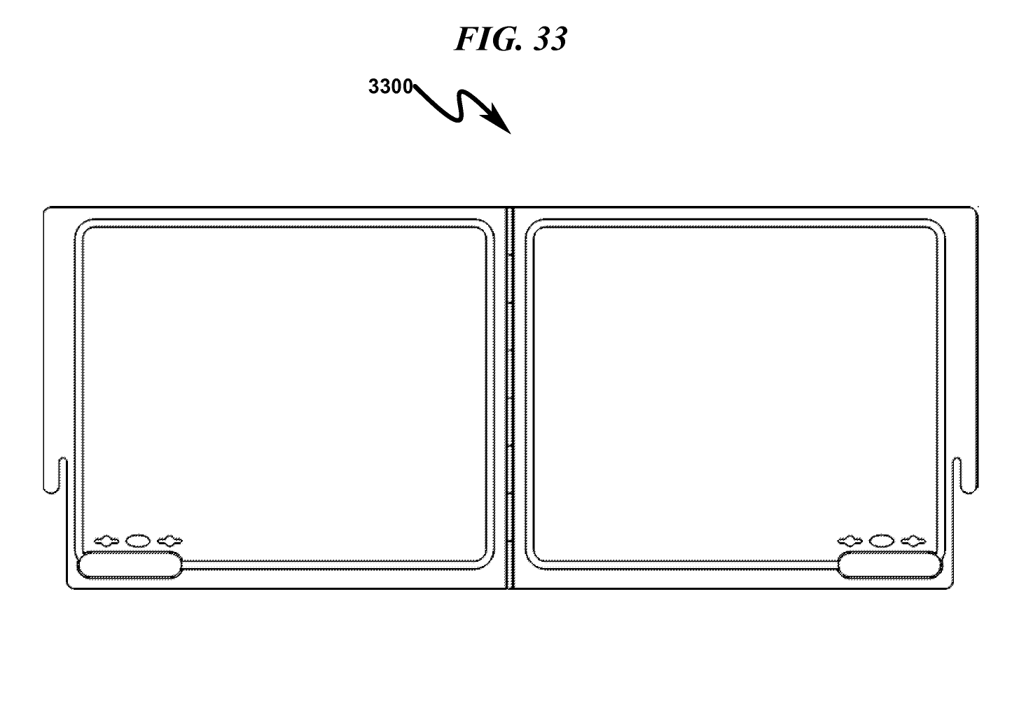

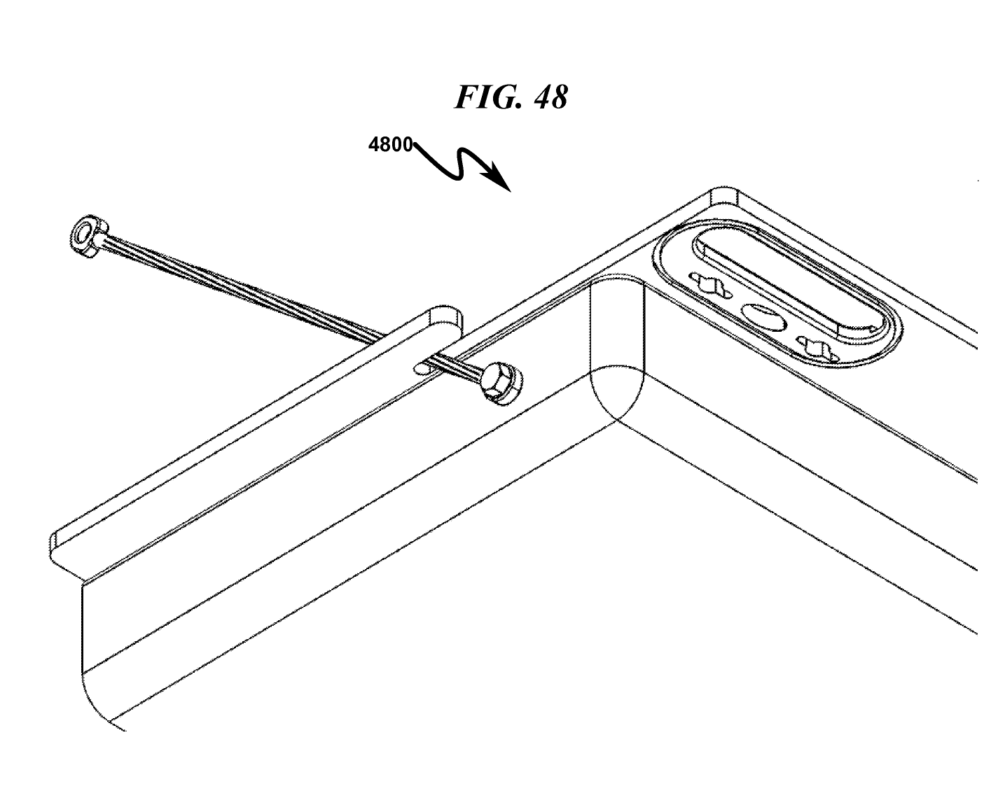

As generally illustrated in FIG. 33 (3300)-FIG. 48 (4800), an alternate preferred exemplary invention system embodiment may bifurcate the food preparation surface using a hinge (3501) positioned at the middle of the cutting surface to permit installation and storage of the system. Normally a prior art cutting board configured to cover the tailgate of a pickup truck might be sized at approximately 63 inches in width by approximately 18-20 inches in depth. The present invention increases this depth and width to accommodate the incorporation of handles/waste ports at the rear of the tailgate and the use of cable capture slots at the sides of the cutting surface to engage the tailgate support means.

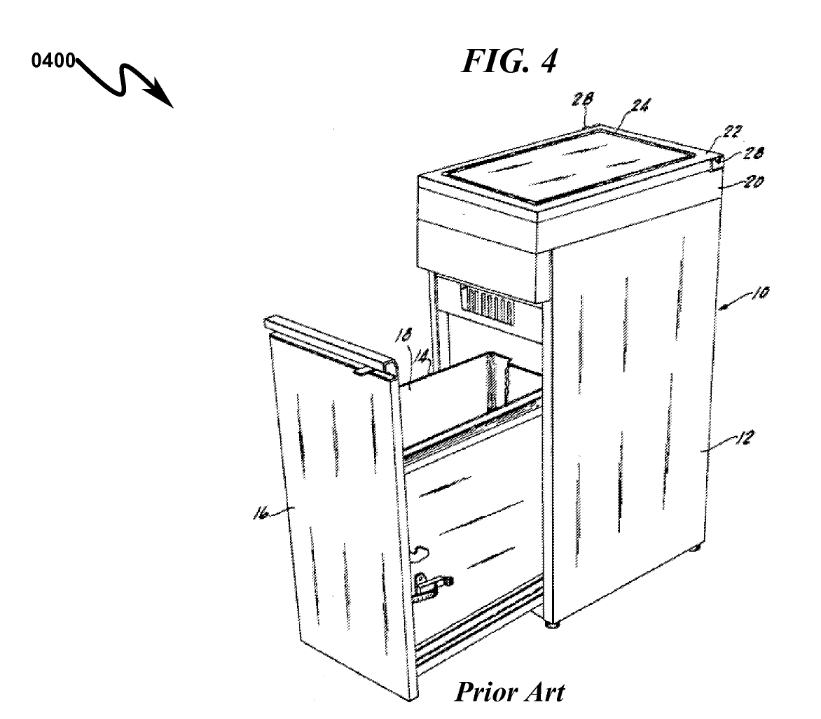

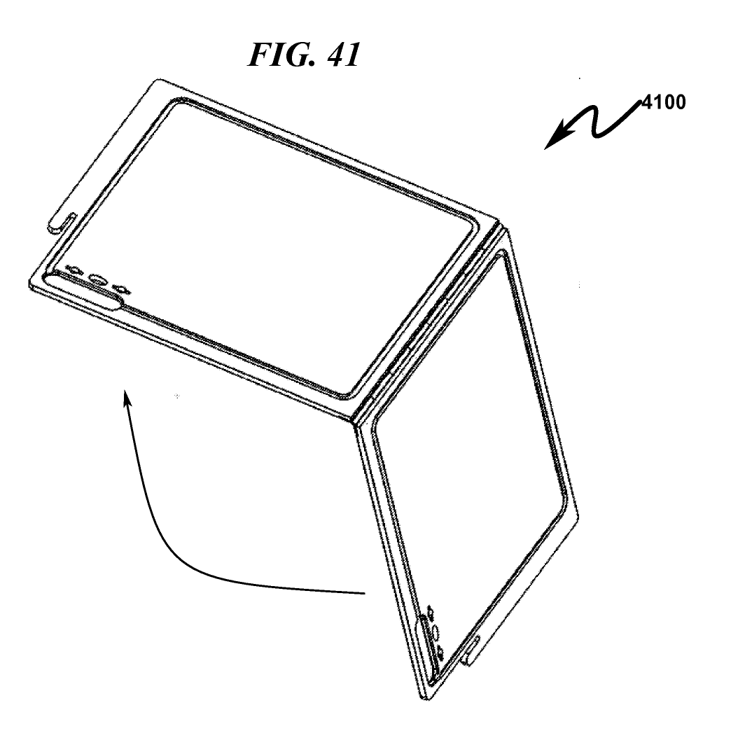

By incorporating a hinge in the center of the cutting surface, this alternate preferred invention embodiment may be folded as depicted in FIG. 41 (4100)-FIG. 4 (4400) for easy storage. The incorporation of the hinge also permits an additional isolation gap between the separate food preparation surfaces on the left and right of the system and thus decreases the chances of cross-contamination between the separated cutting surfaces.

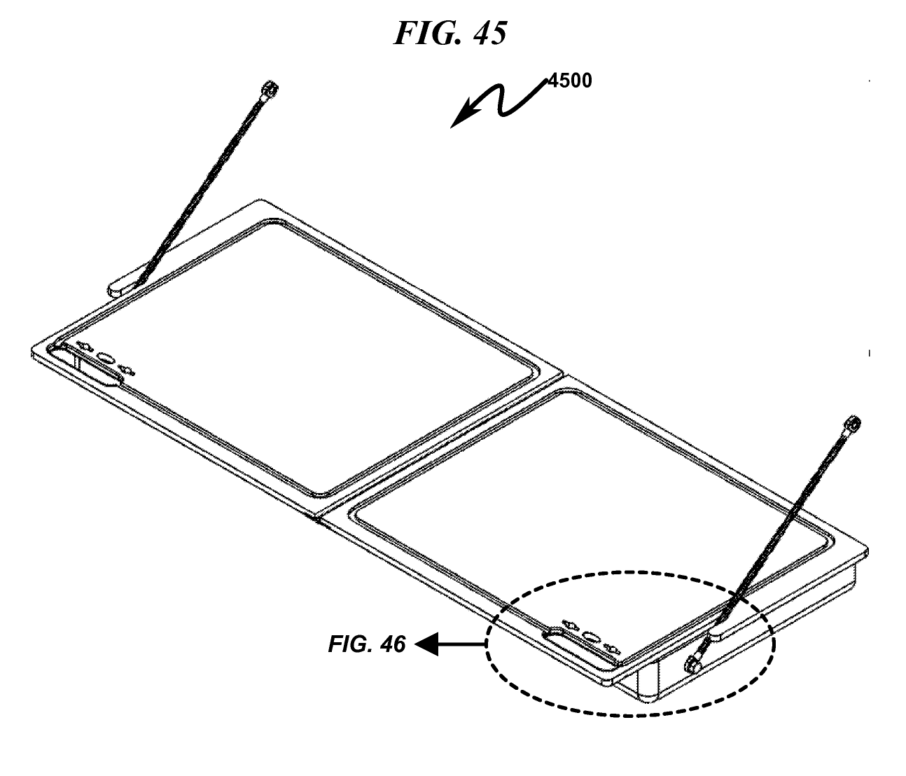

The folding capability of this embodiment also eases the installation of the system in the context of a pickup tailgate as generally illustrated in FIG. 45 (4500)-FIG. 48 (4800), as the system may be unfolded to engage the tailgate support cables/chains and positioned to contact the rear of the truck bed for positive control of the food preparation surface during normal operation. Note that this means of attachment to the tailgate does not require any fasteners or clamps as taught by the prior art, yet provides a secure and stable surface on which food preparation may occur. The ability to fold the system enhances the ability to install the system on the tailgate as each side of the cutting board may be separately engaged with the tailgate cable/chain as the cutting board is unfolded.

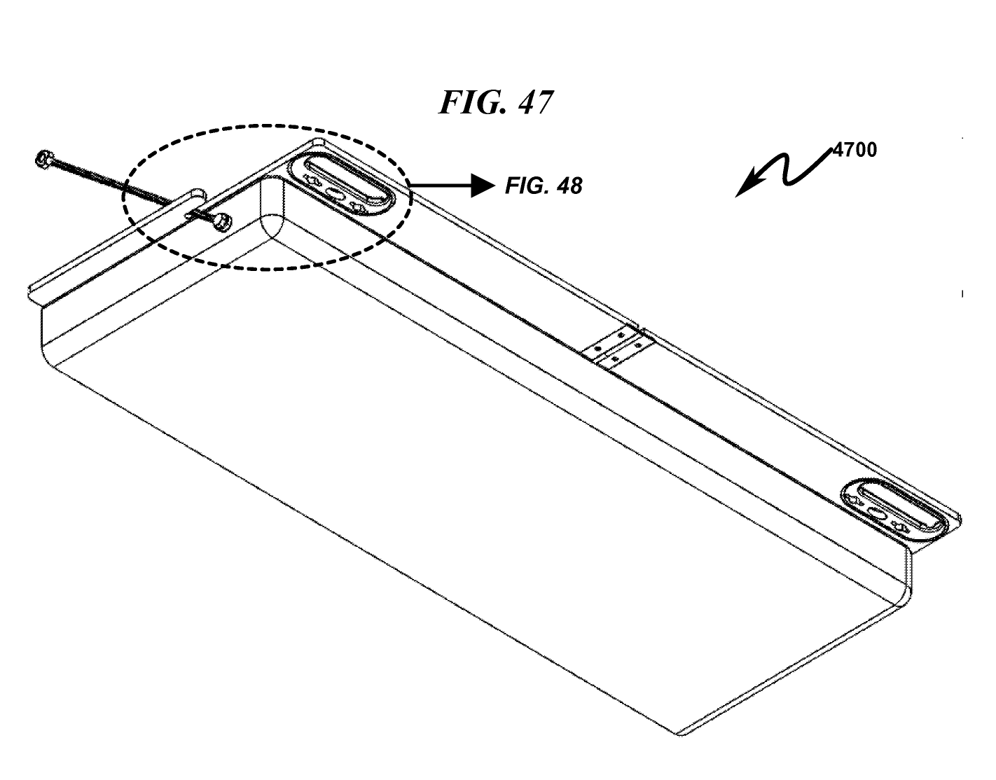

Note the overhang of the cutting board waste ejection ports over the edge of the tailgate as depicted in FIG. 47 (4700)-FIG. 48 (4800). This permits food preparation waste to be collected without contamination of the tailgate, thus reducing the amount of cleanup necessary after food preparation is complete. It should be noted that contaminated food preparation waste in the form of liquids can easily contaminate the INSIDE SURFACES of the tailgate metal shell if this liquid is allowed to wick onto the bottom surface of a traditional cutting board. Thus, the drainage lips formed surrounding the waste ejection ports/handles serve an important purpose in eliminating the potential tailgate contamination.

### System Embodiment

### Optional Drainpipe (4900)-(5200)

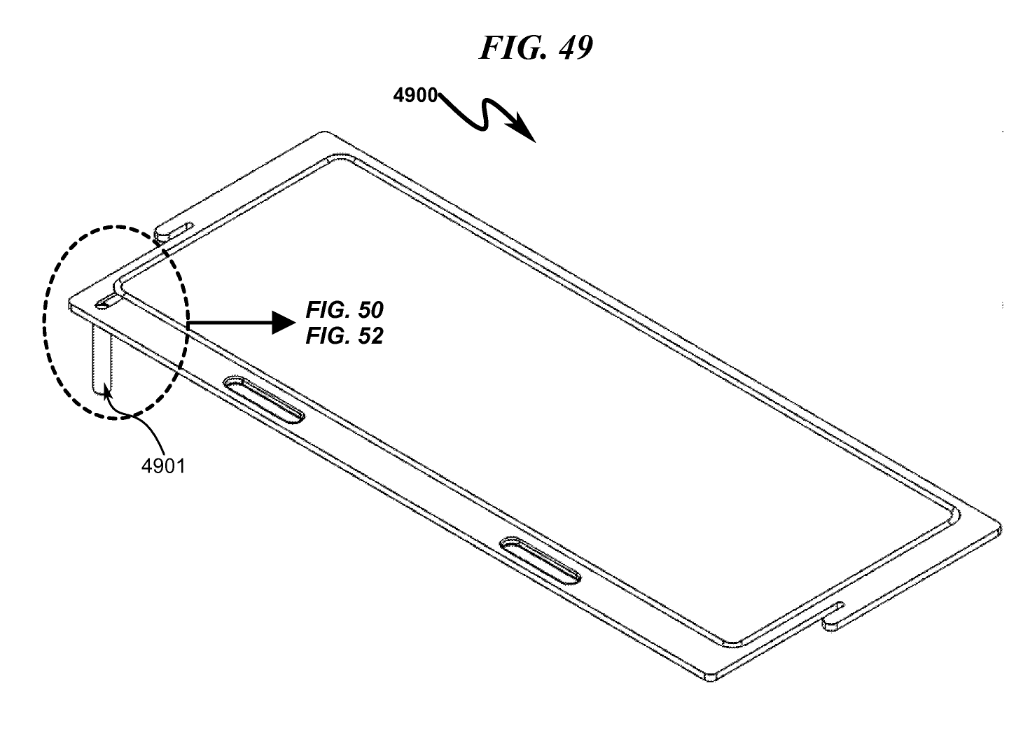

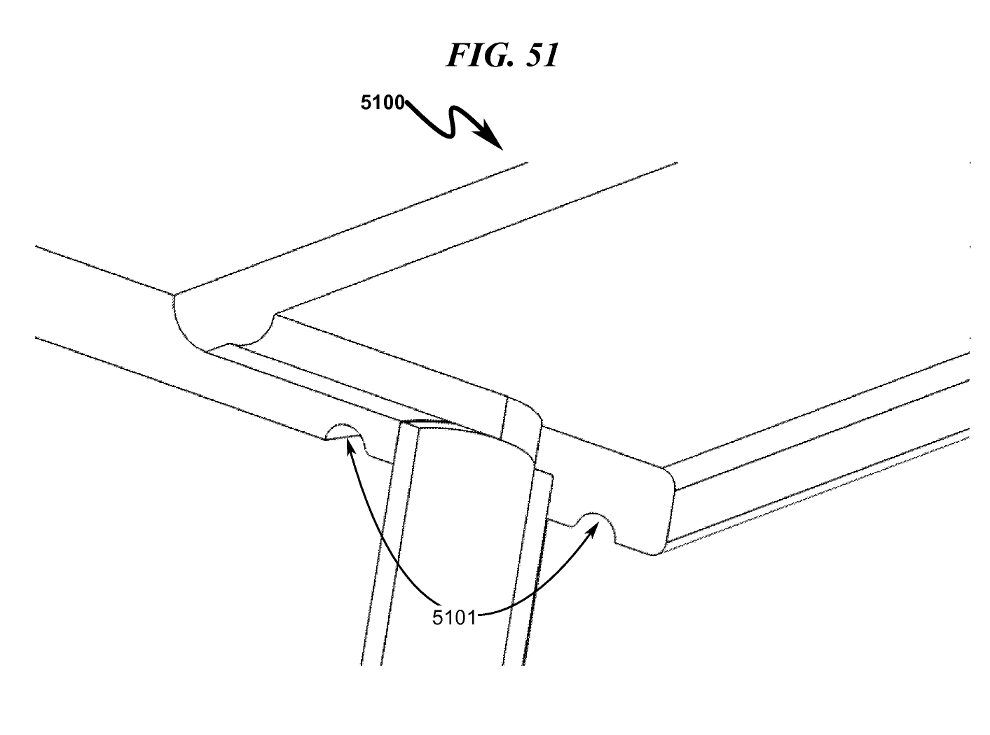

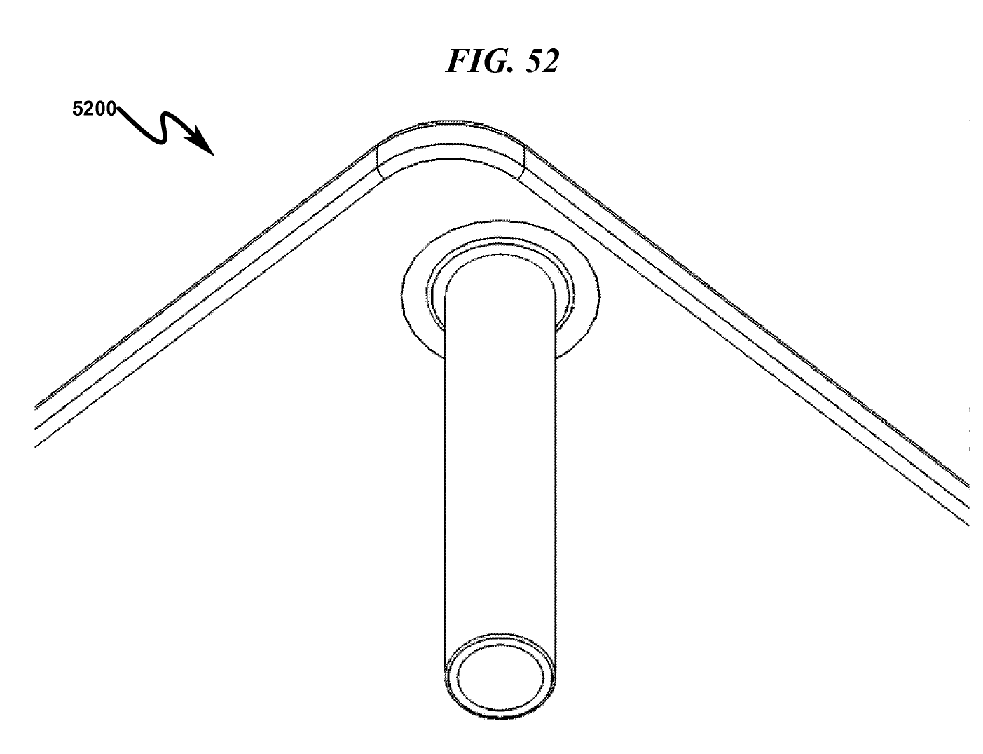

As generally illustrated in FIG. 49 (4900)-FIG. 52 (5200), an alternate preferred exemplary invention system embodiment may form the waste drainage port to support the use of an optional drainpipe (4901) positioned at one or more front corners of the food preparation surface. The outer peripheral drainage slot formed into the top surface of the food preparation surface may be formed as depicted in the sectional view of FIG. 51 (5100) to enable drainage into the optional drainpipe as well as operation as a normal drainage port without the optional drainpipe. Note within this context the incorporation of the drip containment ring (5101) as described previously to ensure that liquid ejected from the drainage port is localized to the area of the drainage port and is not permitted to contaminate the bottom surface of the cutting board or the tailgate of the vehicle.

### System Embodiment

### Edge Drain (5300)-(5600)

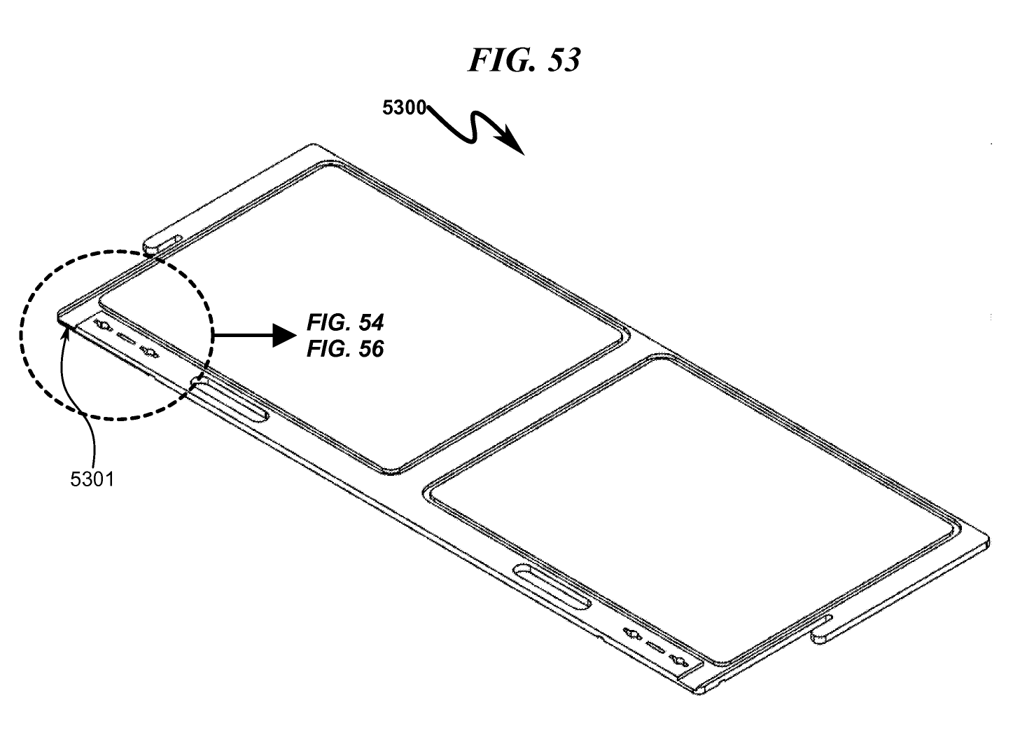

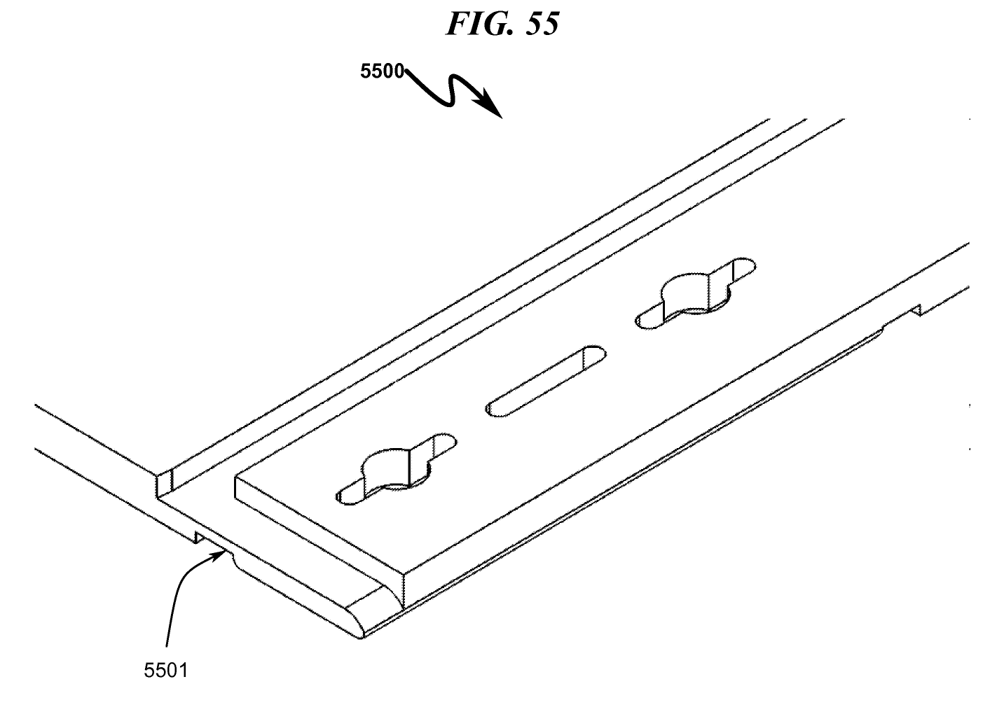

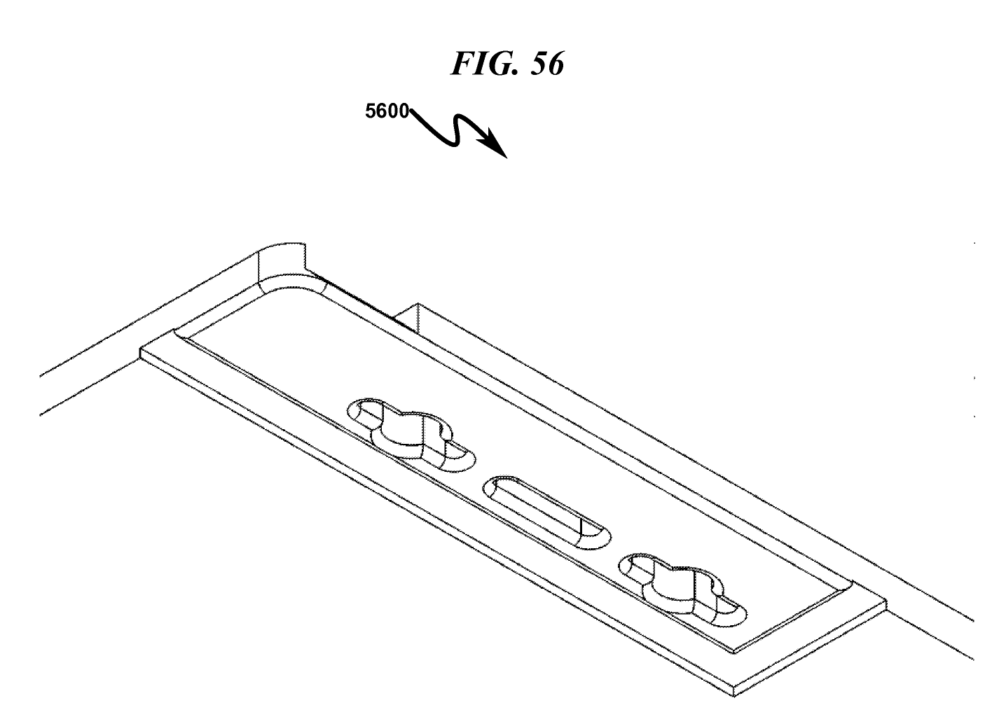

As generally illustrated in FIG. 53 (5300)-FIG. 56 (5600), an alternate preferred exemplary invention system embodiment may form the waste drainage port at the edge of the surface (5301) so that the liquid waste is ejected at the edge of the food preparation surface. The outer peripheral drainage slot formed into the top surface of the food preparation surface may be formed as depicted in the sectional view of FIG. 55 (5500) to enable drainage into the edge drain. Note within this context the incorporation of the drip containment ring (5501) as described previously to ensure that liquid ejected from the drainage port is localized to the area of the drainage port and is not permitted to contaminate the bottom surface of the cutting board or the tailgate of the vehicle.

### Exemplary Application Contexts (5700)-(6400)

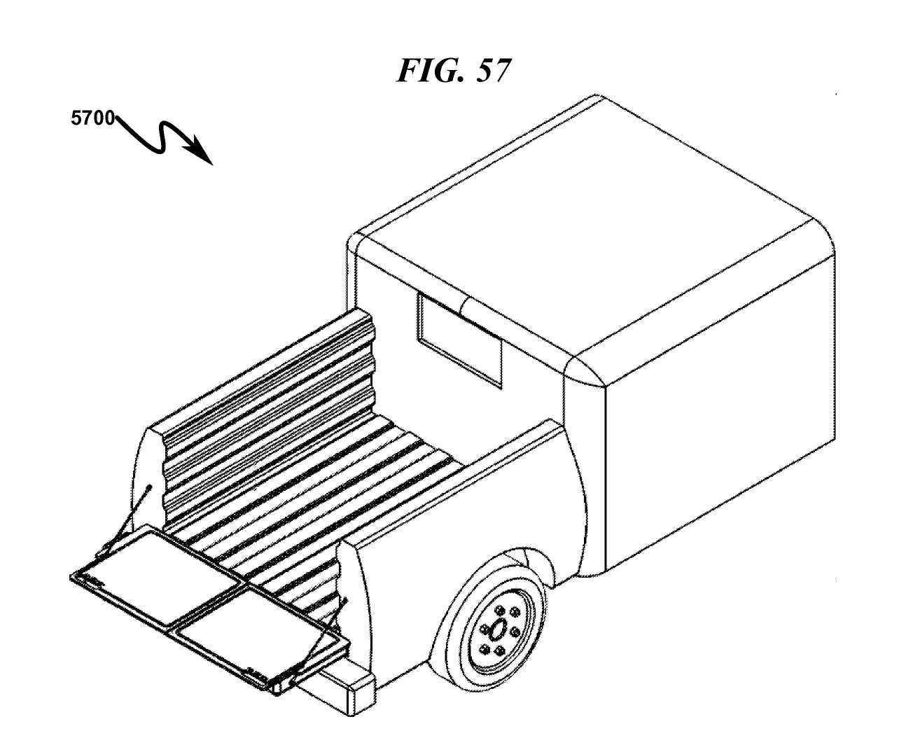

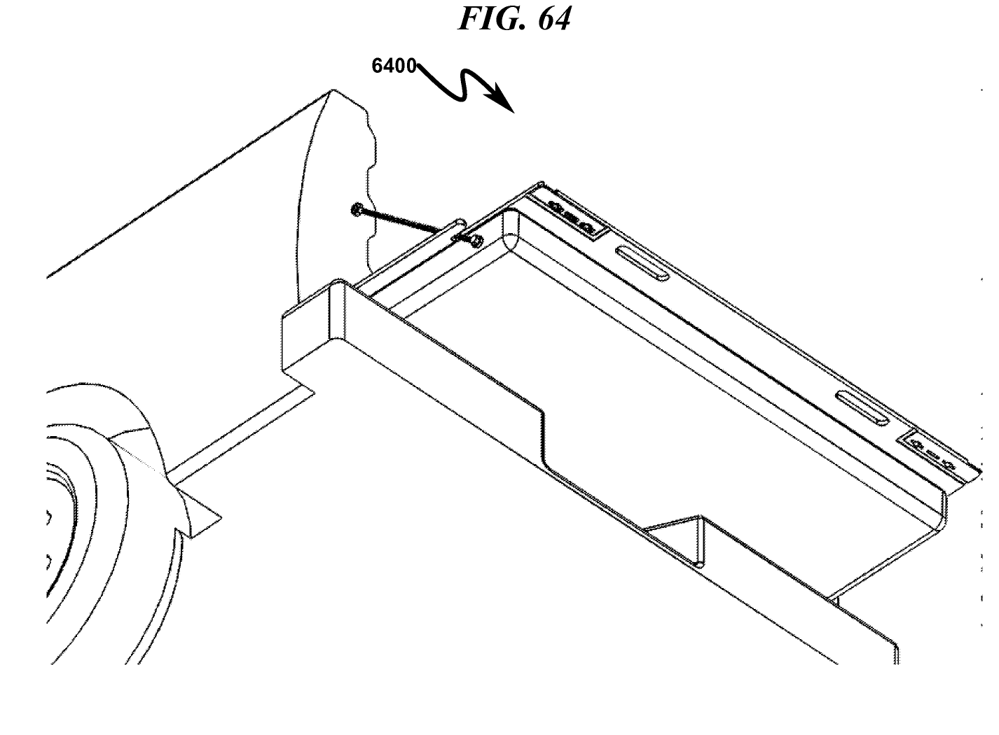

As generally depicted in the application examples provided in FIG. 57 (5700)-FIG. 64 (6400), the various invention embodiments discussed herein are particularly well adapted for use in pickup truck tailgates where the waste products may be collected using a conventional bucket or other waste receptacle. These examples illustrate the positive engagement of the food preparation surface with the tailgate and tailgate support cables/chains to secure the surface for food preparation. Additionally, the front waste ejection ports with drip containment rings permits food to be prepared and waste products to be captured without contamination of the tailgate surface, an important feature when processing meat collecting from hunting and fishing expeditions. Note that the folding embodiment of the present invention permits the system to be reduced in size for easy storage in the truck bed or within the truck cab and also aids in the installation of the system when engaging the left and right tailgate cable/chain supports.

### Preferred Embodiment System Summary

The present invention preferred exemplary system embodiment anticipates a wide variety of variations in the basic theme of construction, but can be generalized as a food preparation system comprising:
(a) food preparation platform (FPP);
(b) lifting handle structure (LHS);
(c) drainage groove structure (DGS);
(d) drainage hole structure (DHS); and
(e) drip containment ring (DCR);
wherein
the FPP is configured for placement on a vehicle tailgate to substantially cover the surface of the tailgate between the confines of the supports for the tailgate and extend beyond the rear lip of the tailgate;
the LHS is formed as an extrusion slot cut through the surface of the FPP and positioned substantially parallel to the peripheral edge of the FPP;
the DGS is formed as an extrusion cut through the top surface of the FPP proximal to the peripheral edge of the FPP and configured to collect fluid present on the top surface of the FPP;
the DHS is formed as an extrusion cut through the surface of the FPP and located at a corner of the FPP and configured to evacuate the collected fluid received from the DGS; and
the DCR is formed as an extrusion cut in the bottom surface of the FPP surrounding the DHS to localize dripping of the collected fluid from the DHS to the surface area between the DCR and the surface of the DHS.

This general system summary may be augmented by the various elements described herein to produce a wide variety of invention embodiments consistent with this overall design description.

### Preferred Embodiment Method Summary

The present invention preferred exemplary method embodiment anticipates a wide variety of variations in the basic theme of implementation, but can be generalized as a food preparation method, the method operating in conjunction with a food preparation system comprising:
(a) food preparation platform (FPP);
(b) lifting handle structure (LHS);
(c) drainage groove structure (DGS);
(d) drainage hole structure (DHS); and
(e) drip containment ring (DCR);
wherein
the FPP is configured for placement on a vehicle tailgate to substantially cover the surface of the tailgate between the confines of the supports for the tailgate and extend beyond the rear lip of the tailgate;
the LHS is formed as an extrusion slot cut through the surface of the FPP and positioned substantially parallel to the peripheral edge of the FPP;
the DGS is formed as an extrusion cut through the top surface of the FPP proximal to the peripheral edge of the FPP and configured to collect fluid present on the top surface of the FPP;
the DHS is formed as an extrusion cut through the surface of the FPP and located at a corner of the FPP and configured to evacuate the collected fluid received from the DGS; and
the DCR is formed as an extrusion cut in the bottom surface of the FPP surrounding the DHS to localize dripping of the collected fluid from the DHS to the surface area between the DCR and the surface of the DHS;
wherein the method comprises the steps of:
(1) placing the FPP on the tailgate of a pickup truck;
(2) engaging the sides of the FPP with the cable/chain supports for the tailgate; and
(3) collecting food preparation waste products from said FPP via ejection from the DHS.
   One skilled in the art will recognize that these method steps may be augmented or rearranged without limiting the teachings of the present invention. This general method summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the FPP comprises a polymer material.
An embodiment wherein the FPP comprises HDPE.
An embodiment wherein the FPP is configured to be in a range of 56 to 86 inches in width and in a range of 20 to 30 inches in depth.
An embodiment wherein the DHS is further configured to accept a pipe for the fluid evacuation.
An embodiment wherein the LHS and the DHS are coincident.
An embodiment wherein the DHS extends to the edge of the FPP.
An embodiment wherein the FPP further comprises two symmetric pieces connected with a folding hinge.
An embodiment wherein the FPP further comprises extrusion cuts within the periphery of the DCR configured to retain food preparation utensils.
An embodiment wherein the FPP further comprises a cable/chain capture slots configured to engage the support means for a tailgate.

One skilled in the art will recognize that other embodiments are possible based on combinations of elements taught within the above invention description.

### CONCLUSION

A food preparation system/method configured for operation with the tailgate of a pickup truck or recreational vehicle is disclosed. The system integrates a food-grade cutting board with lifting/installation handles that may incorporate drainage lips linked to peripheral drainage channels configured to collect liquids and other waste products associated with the food preparation process. The system is configured such that drainage lips used to collect waste liquids employ ridge projections to utilize the surface tension of draining liquids to localize the ejection of liquid waste products. The drainage lips may be configured with an optional drain pipe to further localize the transfer of waste liquids to a bucket or other receptacle. The system may be configured to maintain lateral stability on the tailgate platform via the use of a rear retaining lip and/or one or more slots configured to capture the tailgate support cables/chains.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

Within the context of the following CLAIMS, the CLAIM PREAMBLE should be considered as limiting the scope of the claimed invention. Within the context of the following CLAIMS, “wherein” clauses should be considered as limiting the scope of the claimed invention.

What is claimed is:

1. A food preparation system comprising:
(a) food preparation platform (FPP);
(b) lifting handle structure (LHS);
(c) drainage groove structure (DGS);
(d) drainage hole structure (DHS); and
(e) drip containment ring (DCR);
wherein
said FPP is configured for placement on a vehicle tailgate to substantially cover the surface of said tailgate between the confines of the supports for said tailgate and extend beyond the rear lip of said tailgate;
said LHS is formed as an extrusion slot cut through the surface of said FPP and positioned substantially parallel to the peripheral edge of said FPP;
said DGS is formed as an extrusion cut through the top surface of said FPP proximal to said peripheral edge of said FPP and configured to collect fluid present on the top surface of said FPP;
said DHS is formed as an extrusion cut through the surface of said FPP and located at a corner of said FPP and configured to evacuate said collected fluid received from said DGS; and
said DCR is formed as an extrusion cut in the bottom surface of said FPP surrounding said DHS to localize dripping of said collected fluid from said DHS to the surface area between said DCR and the surface of said DHS.

2. The food preparation system of claim 1 wherein said FPP comprises a polymer material.

3. The food preparation system of claim 1 wherein said FPP comprises HDPE.

4. The food preparation system of claim 1 wherein said FPP is configured to be in a range of 56 to 86 inches in width and in a range of 20 to 30 inches in depth.

5. The food preparation system of claim 1 wherein said DHS is further configured to accept a pipe for said fluid evacuation.

6. The food preparation system of claim 1 wherein said LHS and said DHS are coincident.

7. The food preparation system of claim 1 wherein said DHS extends to the edge of said FPP.

8. The food preparation system of claim 1 wherein said FPP further comprises two symmetric pieces connected with a folding hinge.

9. The food preparation system of claim 1 wherein said FPP further comprises extrusion cuts within the periphery of said DCR configured to retain food preparation utensils.

10. The food preparation system of claim 1 wherein said FPP further comprises a cable/chain capture slots configured to engage the support means for a tailgate.

11. A food preparation method, said method operating in conjunction with a food preparation system comprising:
(a) food preparation platform (FPP);
(b) lifting handle structure (LHS);
(c) drainage groove structure (DGS);
(d) drainage hole structure (DHS); and
(e) drip containment ring (DCR);
wherein
said FPP is configured for placement on a vehicle tailgate to substantially cover the surface of said tailgate between the confines of the supports for said tailgate and extend beyond the rear lip of said tailgate;
said LHS is formed as an extrusion slot cut through the surface of said FPP and positioned substantially parallel to the peripheral edge of said FPP;
said DGS is formed as an extrusion cut through the top surface of said FPP proximal to said peripheral edge of said FPP and configured to collect fluid present on the top surface of said FPP;
said DHS is formed as an extrusion cut through the surface of said FPP and located at a corner of said FPP and configured to evacuate said collected fluid received from said DGS; and
said DCR is formed as an extrusion cut in the bottom surface of said FPP surrounding said DHS to localize dripping of said collected fluid from said DHS to the surface area between said DCR and the surface of said DHS;
wherein said method comprises the steps of:
(1) placing said FPP on the tailgate of a pickup truck;
(2) engaging the sides of said FPP with the cable/chain supports for said tailgate; and
(3) collecting food preparation waste products from said FPP via ejection from said DHS.

12. The food preparation method of claim 11 wherein said FPP comprises a polymer material.

13. The food preparation method of claim 11 wherein said FPP comprises HDPE.

14. The food preparation method of claim 11 wherein said FPP is configured to be in a range of 56 to 86 inches in width and in a range of 20 to 30 inches in depth.

15. The food preparation method of claim 11 wherein said DHS is further configured to accept a pipe for said fluid evacuation.

16. The food preparation method of claim 11 wherein said LHS and said DHS are coincident.

17. The food preparation method of claim 11 wherein said DHS extends to the edge of said FPP.

18. The food preparation method of claim 11 wherein said FPP further comprises two symmetric pieces connected with a folding hinge.

19. The food preparation method of claim 11 wherein said FPP further comprises extrusion cuts within the periphery of said DCR configured to retain food preparation utensils.

20. The food preparation method of claim 11 wherein said FPP further comprises a cable/chain capture slots configured to engage the support means for a tailgate.
